(19) United States
(12) Patent Application Publication
(10) Pub. No.: US 2004/0225728 A1
(43) Pub. Date: Nov. 11, 2004

(54) Network and communications system for streaming media applications

(76) Inventors: Guy Dwayne Huggins, Kennedale, TX (US); David Allen Kopaniky, Garland, TX (US); Sergey Yasevich, Richardson, TX (US); Christopher Bradley Behrens, Kennedale, TX (US); Matthew Thomas Schmitt, Dallas, TX (US)

Correspondence Address: VINSON & ELKINS L.L.P., 1001 FANNIN STREET, 2300 FIRST CITY TOWER, HOUSTON, TX, 77002-6760, US

(21) Appl. No.: 10/429,386

(22) Filed: May 5, 2003

(51) Int. Cl. G06F 15/16; G06F 15/173

(52) U.S. Cl. 709/223; 709/231

(57) ABSTRACT

The invention is directed to a network for distributing streaming media presentations. The streaming media presentations may take various forms including Windows Media™, among others. The network comprises an intranet having a management server and one or more edge servers. Content creators upload streaming media files and presentations to the management server. The management server then distributes the streaming media files to the edge servers from which the files may be broadcast to multiple viewers. The creation tool may also use a Web-based interface to configure the management server and manage edge servers. A viewer may request the media from the management server and be redirected to an edge server for retrieval of the streaming media. The edge server, if it has not cached the streaming media, may acquire the streaming media from the management server and simultaneously distribute the stream and cache the file.

### TECHNICAL FIELD OF THE INVENTION

This invention, in general, relates to networks for broadcasting streaming media presentations. More specifically, this invention relates to networks, tools, and methods for providing a distributed streaming media presentation.

### BACKGROUND OF THE INVENTION

With the growth of the Internet and the increasing costs of travel, streaming media presentations are becoming an important tool for communicating among business associates. Streaming media presentations have also become important for communicating with employees, providing on-demand training, and entertainment. If a streaming media presentation is archived, it also permits those that missed the meeting to review what happened.

However, various network limitations prevent extensive use of streaming media systems. Barriers such as network capacity and conflicts with security limit the availability of streaming media presentations to broader audiences. FIG. 1 depicts an exemplary prior art network which may be limited in its use of streaming media presentation software or capabilities. A system 10 depicts a service provider 12 outside a firewall 14. Within the firewall 14 is a typical network structure with a central access point 16 and branch access points 18 and 20. These access points may take the form of routers or switches. Users 21 and 22 are coupled to the branch access point 18 and 20. A user 21 creates a multimedia presentation for broadcast to users 22 connected to both branch access points 18 and 20. The user 21 would transfer the multimedia files to the service provider 12 through the branch access point 18, central access point 16, and firewall 14. The service provider 12 then transfers or broadcasts the presentation back through the firewall 14, the central access point 16, and each of the branch access points 18 and 20.

Such an architecture poses several problems. The firewall 14 may limit access or transfer of a file into the system. In addition, some firewall systems 14 restrict the flow of data from certain users or regarding certain port accesses. The firewall 14 typically reads packets before permitting packet transfer, extending the amount of time it takes for a packet to reach a distant end. These limitations may prevent this data transfer altogether or make the presentation appear choppy or disjointed.

Another limitation is in the bandwidth or capacity of the network links. The service provider 12 may receive one signal and transfer back five signals in this case. As more users 22 are added to the system, the capacities of the various network lines are taxed. For example, the capacity between the firewall and the central access point may have a load of one transfer out and five transfers in. From the central access point to the branch office, a typical connection has limited bandwidth. In this case, from a central access point 16 to the branch 20, three signals are required in order to satisfy the request of users 22. For branch access point 18, one output signal 21 and two input signals for users 22 are required, each of these taxing the capacity of the network lines.

It is easily seen that these systems then fail to scale for a company with many branch offices and many more users. Extensive access to streaming media would cripple the network. To prevent such problems, many network administrators disallow streaming media usage. As such, many typical network architectures and streaming media systems are deficient in providing scalable and reliable streaming media capabilities. Many other problems and disadvantages of the prior art will become apparent to one skilled in the art after comparing such prior art with the present invention as described herein.

### SUMMARY OF THE INVENTION

Aspects of the invention are found in a network. The network is an intranet having at least one management server and several edge servers. Users who create content may access the management server to establish broadcast channels, publishing points, and settings associated with each. The user may then stream a media file to the management server for broadcast or storage. Viewers then request a media stream from the management server. The management server may redirect the user to an edge server. The edge server transmits the streaming media files to the viewer.

Further aspects of the invention are found in a management server. This server may contain network interfaces and an archive for storing streaming media broadcasts. The management server may have an edge server task list and edge configuration files. The edge server task list may be accessed by edge servers to periodically acquire a task. This task may be associated with configuring the edge server using the edge server configuration file or data supplied in the task listing. Alternately, the task list may direct the edge servers to download data from an archive. The management server may also have a permissions list. The permissions list may be used to ascertain which functions are provided to which users. In conjunction with the permissions list and location on a network, a user may be provided with a subset of a channels or broadcast settings with which the user can create a streaming media presentation. The management server may also collect subscriber data. In this manner, viewers may be tracked. The management server may further have pages and instruction files that permit access to and configuration of the management server. In one exemplary embodiment, most of the communications utilize HTTP.

Additional aspects of the invention are found in a method for accessing streaming media files. A viewer may communicate with the management server, requesting a broadcast or streaming of an archived file. The management server may direct the viewer to acquire a media stream with a given version number from an edge server. The viewer may then request the streaming media file with the version number from the edge server. The edge server may ascertain whether the requested version of the media is located on the edge server. If not, the edge server may acquire the media stream from the management server. The edge server may simultaneously cache and broadcast the media stream to the viewer. The viewer may periodically ping the management server or the edge server to inform the servers of its presence and/or to transfer questions entered by a user of the viewer.

Aspects of the invention are also found in a creation device. The creation device may have a creation tool for creating streaming media presentations. The system may also have a set of drivers. The system may stream media in multiple formats or at multiple bit rates. In one implementation, a ghost driver may be used to capture and encode two streaming media files. The two media streams may differ in format, bit rate, or quality, among others.

As such, a streaming media network is described. Other aspects, advantages and novel features of the present invention will become apparent from the detailed description of the invention when considered in conjunction with the accompanying drawings.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIG. 1 is a schematic block diagram depicting an exemplary prior art network;

FIG. 2 is a schematic block diagram depicting an exemplary embodiment of a network, according to the invention;

FIG. 3 is a schematic block diagram depicting an exemplary embodiment of a communication between a creation device and a management server;

FIG. 4 is a schematic block diagram depicting an exemplary embodiment of a network for communication between a management server and a viewer;

FIGS. 5, 6, 7 and 8 are block flow diagrams depicting exemplary methods for use by the system;

FIG. 9 is a schematic diagram depicting an exemplary management server, according to the invention;

FIG. 10 is a schematic diagram depicting an exemplary edge server, according to the invention;

FIG. 11 is block diagram depicting an exemplary creation device, according to the invention;

FIG. 12 is a block diagram depicting an exemplary user device, according to the invention;

FIGS. 13-26 are pictorials of an exemplary embodiment of a creation tool, according to the invention;

FIGS. 27 and 28 are exemplary methods for use by the invention;

FIGS. 29, 30, 31A and 31B depict an exemplary embodiment of an interface with a management server;

FIG. 32 is a pictorial depicting an exemplary viewer;

FIG. 33 is a schematic block diagram depicting an exemplary embodiment of communication between a user, management server and edge server; and

FIGS. 34-42 depict block flow diagrams depicting exemplary methods for use in the invention.

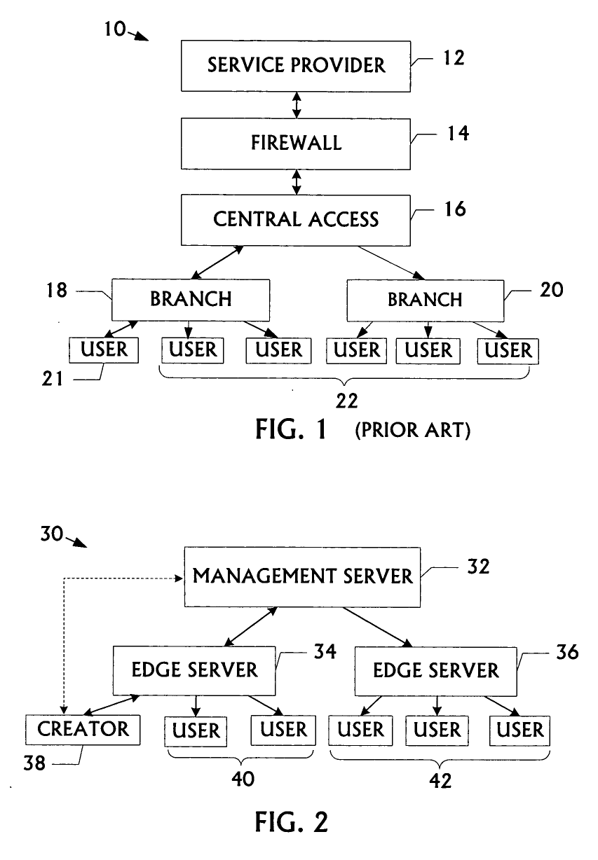

### DETAILED DESCRIPTION OF THE INVENTION

An intranet environment is a managed network with known limitations and structure. A streaming media distribution system designed to adapt to these known limitations and structures is less likely to tax the capacity of the network. In addition, system may be made more secure without the need for firewall interference. Using a management server that distributes media to known network nodes in proximity to users and within the intranet provides for a lower bandwidth solution than external service provider structures. In addition, the creation and distribution may be adapted to the fit known bandwidth and network capacity limits. As such, the system is cost effective and network capacity efficient.

FIG. 2 is a schematic diagram of an exemplary intranet. The intranet 30 has a management server 32 connected to edge servers 34 and 36. A streaming media creation device 38 may communicate with the management server 32 or the edge server 34 to provide a broadcast. If the broadcast is to take place among users 40 associated with the edge server 34, the creation device 38 may establish a publishing point at the edge server 34 and distribute streaming media to the users 40. The creation device 38 may then communicate with the management server 32 to archive the file. At a later time, the edge server 36 and users 42 may acquire the archived file from the management server 42.

In another exemplary embodiment, the creation device 38 may communicate with the management server 32. Upon request from the users 40 and 42, the management server 32 may retrieve the stream from edge server 34 and stream media to edge server 36. In this scenario, since creator 38 is on the same subnet as edge server 34, the stream is sent from creation device 38 to edge server 34 and served to users 40. Thus the traffic is contained in the local subnet unless a request comes from users 42 on another subnet. Users 42 may request the stream from edge server 36, which in turn requests it from management server 32. The management server 32 in turn requests it from edge server 34. In this manner, the communications channel between the management server 32 and edge servers 34 and 36 or users 40 and 42 are not tasked by requests for multiple instances of streaming media files. However, various transfer scenarios may be envisioned.

A management server 32 and edge servers 34 may take the form of various servers known in the art. The creation device 38 and users 40 and 42 may take various forms including desktop computers, laptop computers, notebook computers, PDAs, ultra portable computers, and smart devices, among others. The network 30 may take various forms and communicate with various standards including Ethernet, wireless Ethernet, TCP/IP, UDP, among others. Network packet may also conform to various standards including HTTP, Microsoft Media Server Protocol (MMSP), Real Time Streaming Protocol (RTSP), SMTP, and FTP, among others.

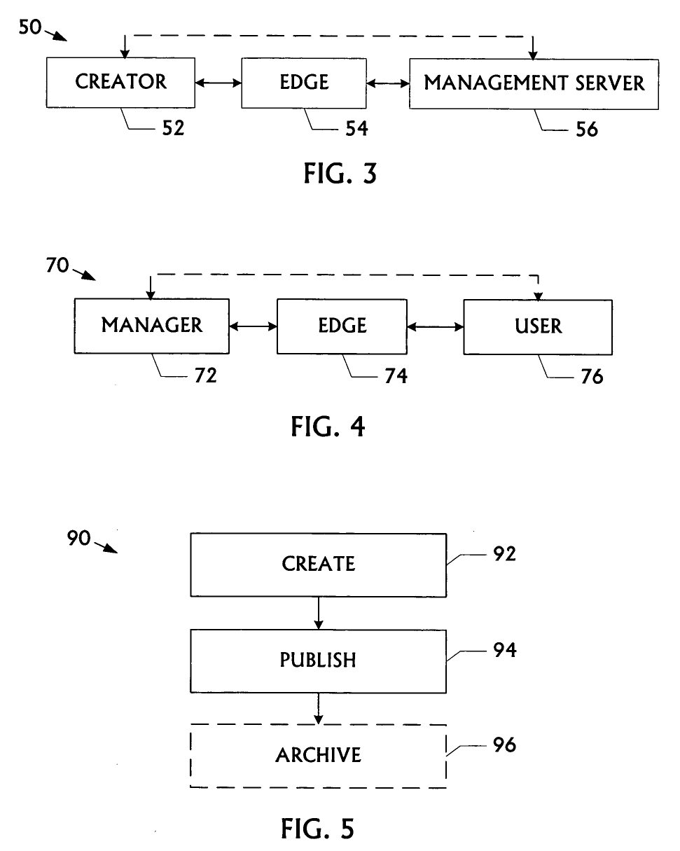

FIG. 3 is a schematic block diagram depicting an exemplary communication between a creation device 52 and a management server 56. The creation device 52 may communicate directly with the management server 56 to upload control data and file date. In the event that the streaming media is to be distributed among many viewers associated with differing edge servers, the creation device 52 may stream media to the edge server 54 and the management server 56 may acquire the stream from the edge server 54. The management server 56 may then distribute the media to other edge servers. However, various structures and transfer paths may be envisioned. Similarly, the creation device 52 may archive streaming media with the management server 56 for later editing and on-demand access, among others.

Alternately, the creation device 52 may communicate with an edge server 54. This case may be useful when each viewer is associated with the edge server 54 associated with the creation device 52. In this manner, the edge server 54 may act as a publishing point. Further, the creation device 52 may subsequently archive the broadcast on management server 56.

FIG. 4 depicts communication from the management server to the user 76. The user 76 may request a broadcast or staged streaming media file. The management server 72 may inform the user 76 of the edge node 74 and a version of the streaming media file. The user 76 may then request the version of the streaming media file from the edge server 74. If the edge server 74 does not have the specific version of the file, the edge server 74 may request the file from the management server 72. The edge server 74 may then simultaneously cache the streaming media file and deliver the streaming media file to the user 76.

FIG. 5 depicts a method 90 for use by the system. A user may create the streaming media presentation as seen in a block 92. The streaming media presentation may take various formats including Windows Media™, Real Networks™ media, Quicktime™ media, and MPEG media, among others. The user may then seek to publish the created streaming media as seen in a block 94. The publication may include communicating with a management server or edge server. Through this communication, the user and servers may establish a set of parameters associated with the bandwidth and quality of the transmission and the permission and availability of the broadcast to members of a network. The permission and availability may further dictate which server, the management server or the edge server, acts as a publishing server. As the files are being broadcast, the creation device may further archive the files for editing and subsequent delivery as an on-demand presentation.

For example, a creation tool associated with a creation device may fill an HTML form from the management server with data associated with a broadcast and establish a channel. Alternately, an existing broadcast or parameter set may be selected from an HTML page. The creation tool may then be used to mix a set of media inputs such as slide images, audio files, video files, and input streams such as audio and video feeds. These files may be uploaded and/or streamed to a management server. The management server may store these files, broadcast them, upload them to edge servers, or perform various combinations of the above. However, various examples may be envisaged.

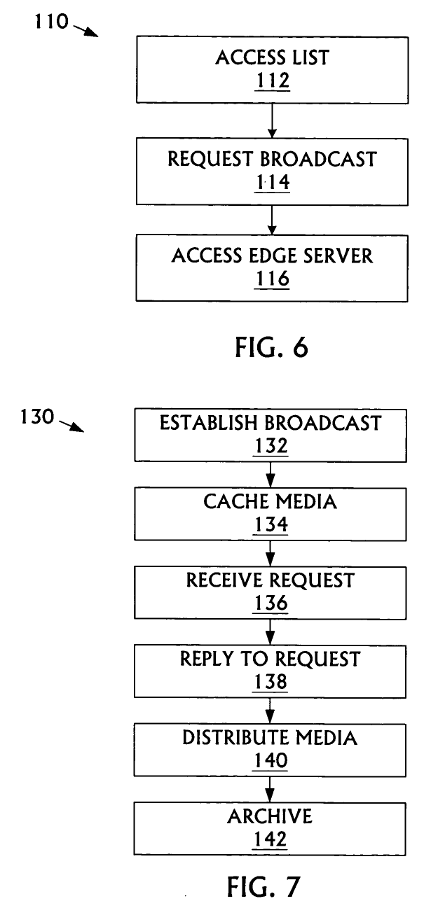

FIG. 6 depicts the actions of a viewer seeking access to the broadcast or on-demand media data. As seen in the method 110, the user may access a list of available streaming media files as seen in block 112. The list presented to the viewer may be a subset of the available archived, on-demand, and broadcast streaming media files available based on the viewer's identification, or network location and capacity, among others. From this list, the viewer may request a broadcast as seen in block 114. This request may take the form of a communication with a management server. The management server may then notify the viewer of a location of an edge server and a version of the media. The viewer may then access the edge server as seen in a block 116. The edge server may have the version requested or may retrieve the version from the management server and broadcast it to the viewer.

In one exemplary embodiment, the viewer has a browser that access HTML or XML pages on the management server. The management server then initiates a media player and directs the player to a edge server. The edge server then streams the media to the viewer from memory or as it is downloaded from the management server.

FIG. 7 depicts a method for use by a management server. The method 130 may start with the establishment of a broadcast as seen in block 132. This establishment of a broadcast may include the exchange of broadcast settings, permissions, and broadcast timing, among others. The server then stores the media for use in the broadcast as seen in a block 134. This media may include images and slides associated with the streaming media. In addition, the media may include various audio and video streams associated with the broadcast. Subsequently, the server may receive a request from a viewer, as seen in a block 136. For example, the viewer may log in, select a broadcast or on-demand streaming media, and establish broadcast parameters such as bandwidth or stream quality. The server may reply to this request as seen in a block 138. The reply may include the location of an edge server and a version of the streaming media. With this information, the viewer may go to the edge server and access the streaming media. The server may then distribute the streaming media to the edge server as seen in block 140. This distribution may include ongoing media streams, on-demand files, or archived files. The distribution may take place at a scheduled time or upon the request of the edge server. Simultaneously, the streaming media file or broadcast may be archived and later staged on the management server as seen in block 142.

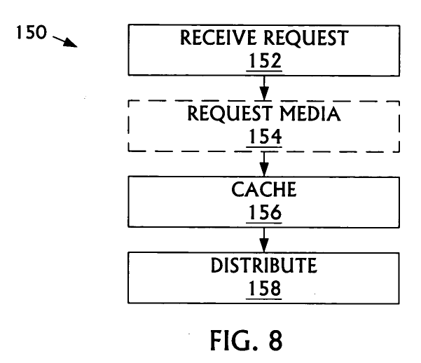

FIG. 8 is a block flow diagram depicting the method of an edge server. The method 150 begins with the edge server receiving the request from a viewer as seen in a block 152. The viewer may request a version of a streaming media file. The edge server may determine whether it has the requested file or media stream and, if it does not, request the media from a management server as seen in a block 154. Subsequently, the server may cache the media stream as seen in a block 156 and distribute that media stream as seen in a block 158. The edge server may simultaneously cache and distribute the file given the appropriate servers and drivers.

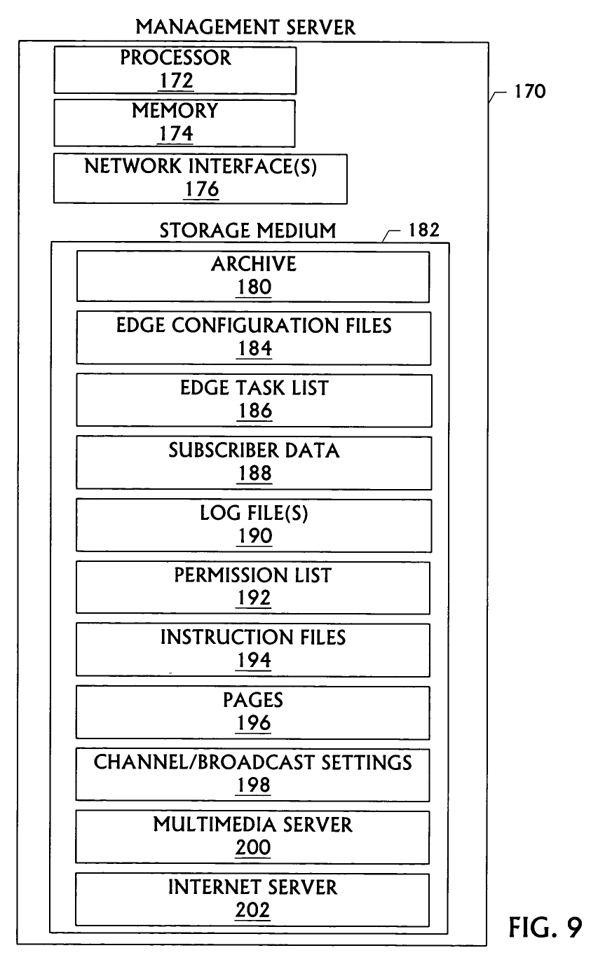

FIGS. 9-12 depict exemplary embodiments of devices for use by the system. FIG. 9 depicts an exemplary management server 170. The management server 170 has a processor 172, memory 174, network interfaces 176, archives 180, storage 182, edge configuration files 184, edge task lists 186, subscriber data 188, log files 190, permission lists 192, instruction files 194, pages 196, channel or broadcast settings 198, multimedia servers 200, and internet servers 202, among others. However, each of these elements may or may not be included together, separately or in various combinations, among others.

The processor 172 and memory 174 may function together to provide the various functionalities described above and below. The processor 172 may take various forms including a variety of computational circuitries useful in interpreting instructions and performing tasks associated with the server. The memory 174 may take various forms including RAM, ROM, flash memory, floppy disks, hard disks, CDs, DVDs, removable drives, and network storage drives, among others. The storage 182 and the memory 174 may or may not be combined.

The network interfaces 176 may function to communicate with the streaming media creation devices, edge servers, and viewers, among others. The network interface may communicate through various hardwire and wired networks and may communicate with various protocols including TCP/IP, UDP, and Ethernet, among others. Further, the network interface 176 may permit the management server to communicate using protocols such as HTTP, MMSP, RTSP, SMTP, and FTP, among others.

The storage medium 182 may take various forms including those described in relation to the memory 174. Within the storage medium may be archives 180, edge configuration files 184, edge task lists 186, subscriber data 188, log files 190, permission lists 192, instruction files 194, pages 196, channel broadcast settings 198, multimedia servers 200, and internet servers 202, among others. The archives 180 may permit the storage of various streaming media files for broadcast or rebroadcast as requested and permitted. The archives may include image files, presentation files, slides, audio files, video files, and various files of streaming media format. The streaming media format files may take the form of Windows Media™, Real Networks™, Quicktime™, MPEG-4, and other standards, among others. In addition, these files may be stored for future editing and rebroadcast in on-demand presentations.

The management server 170 may also act to configure and maintain the configuration of various edge servers. The management server may have or store edge configuration files 184 and edge task lists 186. The edge servers may be configured using data from the edge configuration files and/or the task list 186. The management server 170 may attempt to contact an edge server to implement a change in configuration. In addition, the management server 170 may place an action item in an edge task list 186. The edge server may then periodically access the edge task list 186 and perform a task within the list. The task may include reconfiguring the edge server or downloading an archived file, among other tasks. Once the task is complete, the edge server may delete that task from the task list or notify the management server 170 of the completion of the task. In this manner, edge servers may be managed from a centralized management server for reconfiguring or downloading archived files during off-peak times within the network. Further, the management server may provide a centralized means of tacking edge configuration.

The subscriber data 188 may take the form of various parameters. The subscriber data 188 may be used to track viewer access. In addition, log files 190 may be used to track viewer actions and usage of the system. Further, the log files 190 may be used to track access by creation devices and edge servers. For example, a viewer may periodically ping the management server to inform the management server of its presence and operation. The management server may store this information in the log files 190. The log file 190 and subscriber data 188 may then be used to track attendance or viewing of training videos, among others.

The permissions list 192 may take the form of various data files and databases. The permissions list 192 may provide for the limiting of access to various broadcast settings, archived files, and broadcasts, among others. The permissions list 192 may be tied to users and/or network locations, among others. For example, a broadcast creator may access the management server from a remote site. Based on the identity of the broadcast creator and/or the network location of the remote site, the management server may determine that a limited set of broadcast settings are available. For example, the network location may be tied to the management server through a limited capacity network connection. As such, the management server may limit any broadcast to those formats that conform to the low capacity network connection. In addition, the server may identify the user and provide access to only those files associated with the user or only those edit permissions provided to the user.

The management server 170 may also have instructions 194 and pages 196. The pages 196 may for example, be HTML, XML, or created through programs such as ASP, ASP.NET, PHP, server side JAVA script, CGI, or others. The instruction files 194 may take various formats including compiled programs, database engines, and interpreted instruction sets, among others. Together these pages 196 and instruction files 194 may provide for the access of users to the management server 170 and the functionality of the management server 170. In one exemplary embodiment, the management server may have a set of HTML pages and scripts, which act as a configuration interface for broadcasts, edge servers, and the management server.

Channel and broadcast settings 198 may include settings for existing broadcasts, a set of preset parameters that may be used by viewers and content creators, or a combination of these. For example, viewers and content creators located at remote points on a network may have a network connection that is limited in capacity. The channel or broadcast settings 198 may be established such that users on these remote sections of the network can only use settings that limit taxation of the network. In another example, a content creator may access the management server and establish a new broadcast with data such as the broadcast name, description, start time, media options, type, category, expiration time, and end time, among others.

The management server 170 may also have a multimedia server 200 and an internet server 202. The multimedia server 200 may function to stream media. Multimedia servers 200 may be used to stream Windows Media™, Real Networks media™, Quicktime™ media, and MPEG-4 media, among others. The internet server 202 may function to respond to requests for pages and interfaces, among others.

As such, management server 170 is described that permits communication with content creators based on network settings that do not tax network capacity, communication with edge servers for centralized configuration and management of the edge servers, and communication with viewers that permits maximum utilization of the network while limiting viewer access to broadcasts.

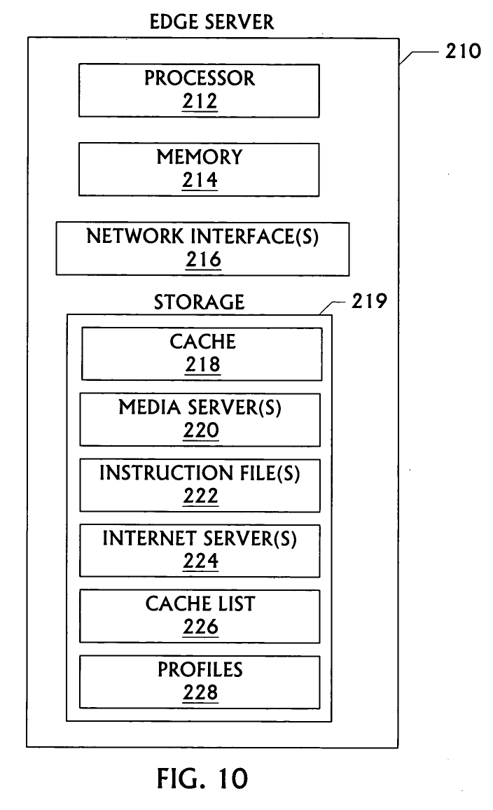

FIG. 10 is a block diagram depicting an exemplary embodiment of an edge server 210. The edge server 210 may have a processor 212, memory 214, network interfaces 216, cache 218, media servers 220, instruction files 222, internet servers 224, cache list 226, and profiles 228, among others. However, these elements may or may not be included together, separately, or in various combinations.

The processor 212 and memory 214 may function together to provide the various functionalities described above and below.

The processor 212 may take various forms including a variety of computational circuitries useful in interpreting instructions and performing tasks associated with the server. The memory 214 may take various forms including PAM, ROM, flash memory, floppy disks, hard disks, CDs, DVDs, removable drives, and network storage drives, among others. The storage 219 and the memory 214 may or may not be combined.

The network interfaces 216 may function to communicate with the streaming media creation devices, management servers, and viewers, among others. The network interface may communicate through various hardwire and wired networks and may communicate with various protocols including TCP/IP, UDP, and Ethernet, among others. Further, the network interface 216 may permit the edge server to communicate using protocols such as HTTP, MMSP, RTSP, SMTP, and FTP, among others.

The storage medium 219 may take various forms including those described in relation to the memory 214. Within the storage medium 219 may be a cache 218, multimedia servers 220, instruction files 222, internet servers 224, cache list 226, and profiles 228, among others. The cache 218 may permit the storage of various streaming media files for broadcast or rebroadcast as requested and permitted. The cache 218 may include image files, presentation files, slides, audio files, video files, and various files of streaming media format. The streaming media format files may take the form of Windows Media™, Real Networks™, Quicktime™, MPEG-4, and other standards, among others. The media servers 220 may function to serve the media files upon request from a viewer.

Instructions 222 permit the edge server to determine when to download media files, responding to tasks stored in the edge server task list on the management server, and managing communications with the viewer, among others. The instructions 222 may take various forms including executables, interpretable code, scripts, and drivers, among others. In one exemplary embodiment, the instruction may permit the simultaneous caching and distribution of a media stream.

The edge server 210 may also have an internet server 224. The internet server 224 may permit the distribution of HTML pages, images, and other media.

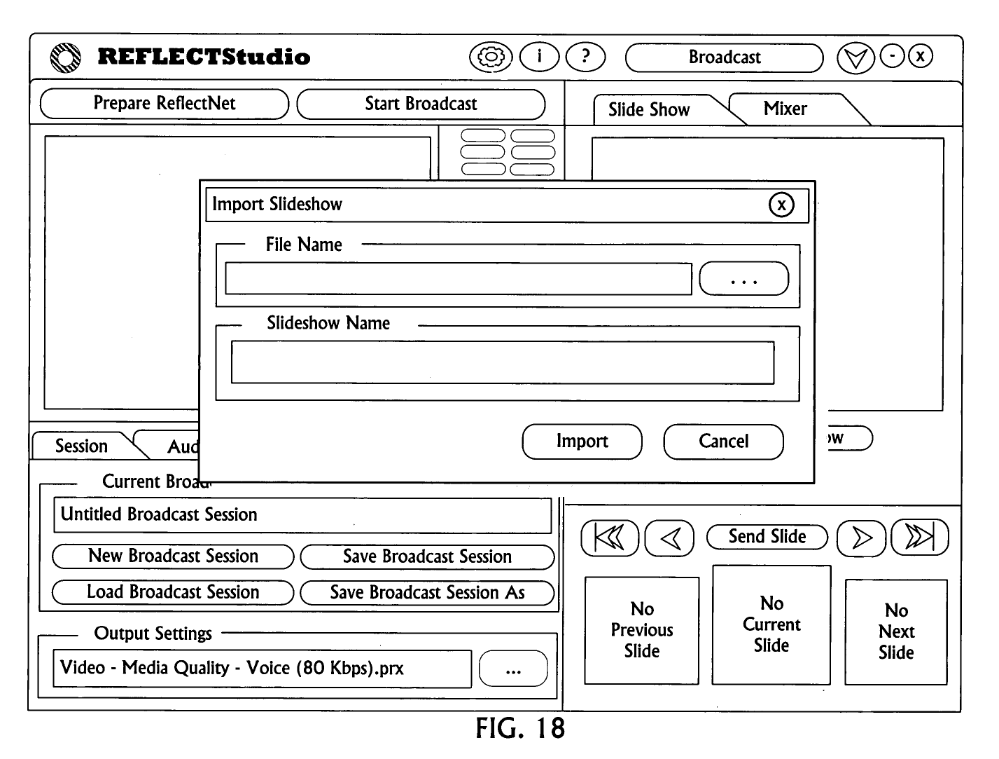

The cache list 226 may be a listing of available cached media files. The listing 226 may include a key, time of last use, file location, and profile data. The listing is discussed in more detail in relation to FIG. 18. The listing 226 may be managed through the management server or with instructions 222. The listing 226 may be used in determining whether a requested version of a file is in cache and managing storage capacity, among other functions.

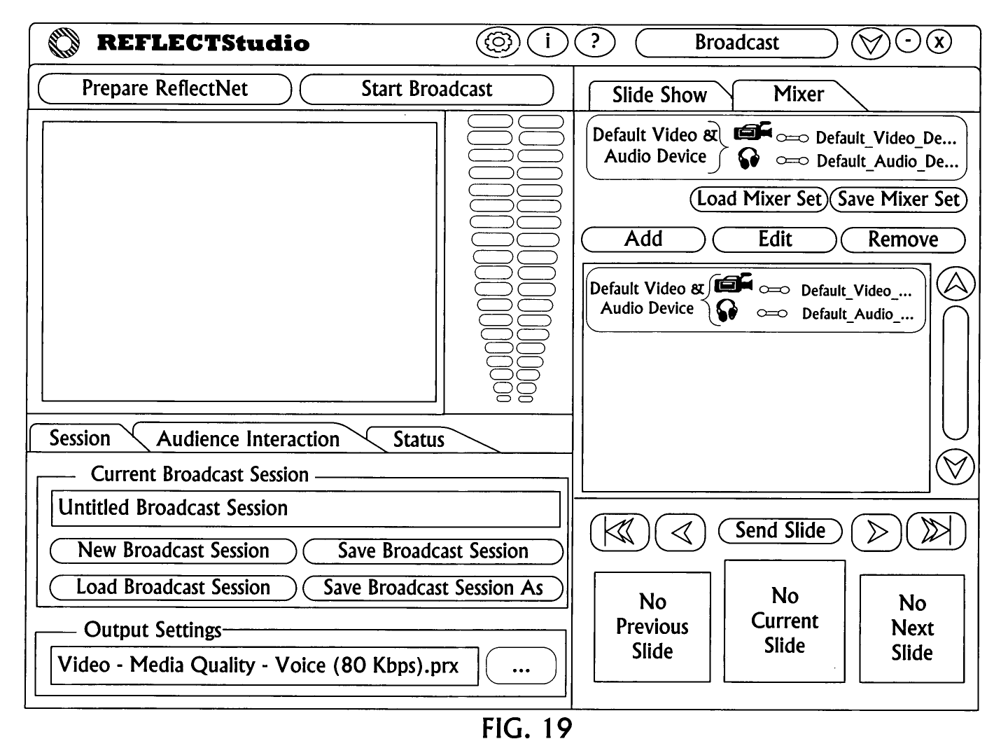

The edge server 210 may also have a profile data 228. The profile data 228 may include listings of webcasts. The listings may have version numbers and file listings with associated timestamps. One exemplary embodiment of the profile 228 is described in FIG. 19. The profile data may also be used in determining whether a requested version of a file is in cache.

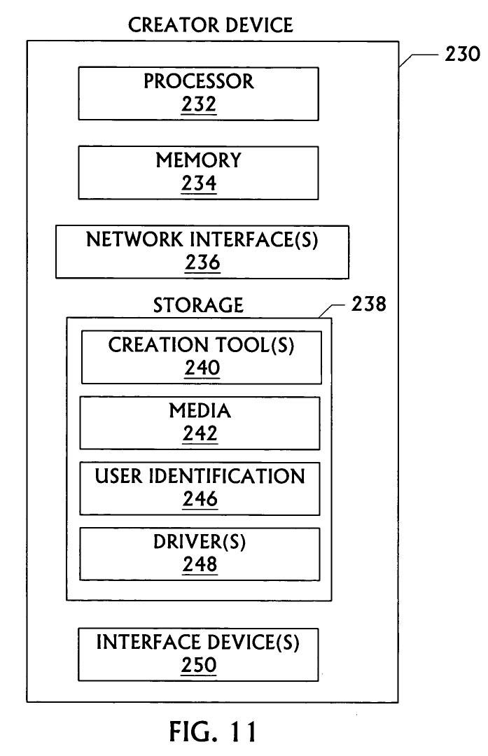

FIG. 11 is a block diagram depicting a content creation device 230. The content creation device 230 has a processor 232, a memory 234, network interfaces 236, storage 238, creation tools 240, media 242, user identification 246, drivers 248, and input devices 250. However, these elements may or may not be included together, separately, or in various combinations, among others.

The processor 232 and memory 234 may function together to provide the various functionalities described above and below. The processor 232 may take various forms including a variety of computational circuitries useful in interpreting instructions and performing tasks associated with the content creation and streaming of that content. The memory 234 may take various forms including RAM, ROM, flash memory, floppy disks, hard disks, CDs, DVDs, removable drives, and network storage drives, among others. The storage 238 and the memory 234 may or may not be combined.

The network interfaces 236 may function to communicate with the streaming media edge servers and management servers, among others. The network interface 236 may communicate through various hardwire and wired networks and may communicate with various protocols including TCP/IP, UDP, and Ethernet, among others. Further, the network interface 236 may permit the content creation device 230 to communicate using protocols such as HTTP, MMSP, RTSP, SMTP, and FTP, among others.

The storage medium 238 may take various forms including those described in relation to the memory 234. Within the storage medium may be a creation tool 240, media 242, user identification 246, and drivers 248, among others.

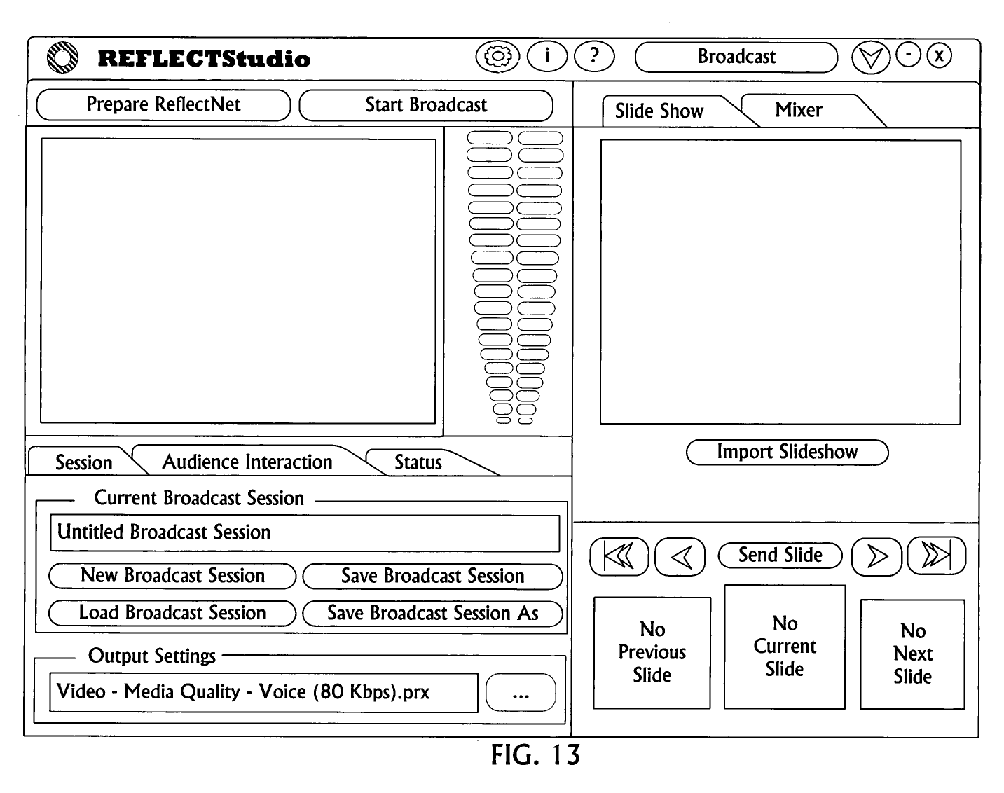

The creation tool 240 may take various forms of tools for creating streaming media. In one exemplary embodiment, the creation tool may take the form as seen in the interface pictorials of FIGS. 13-26. The creation tool 240 may for example, mix media such as an audio/visual feed from a camera and a set of slide images to produce a streaming presentation. In one exemplary embodiment, the creation tool 240 may mix a audio/visual streams from one or more cameras, input in a graphical user interface, and slide images to create a Windows Media™ presentation with slide transition indicators.

The media 242 may take various forms, including streaming media such as Windows Media™, Real Networks™ media, Quicktime™ media, and MPEG-4 media, among others. In addition, the media 242 may take the form of various audio, video, and image formats which may be used in the creation of a streaming media presentation.

The user identification 246 may be provided by a user and used to provide permissions and broadcast settings associated with broadcast and archived files. For example, the user identification 246 may be provided to a management server. The management server may determine that the user has permissions to access a subset of broadcasts or archived files. In another example, the user identification 246 may be used to restrict the streaming media options to media presented to the user to those options with lower bit rates and quality.

In addition, the system may include drivers 248. The drivers 248 may be used to capture streaming media from various input devices. In addition, these drivers 248 may be used to create multiple streams from a single input that vary in bit rate and quality.

The creation device 230 may also include various interface devices 250. These interface devices 250 may include cameras, microphones, mice, keyboards, touch screens, and monitors, among others.

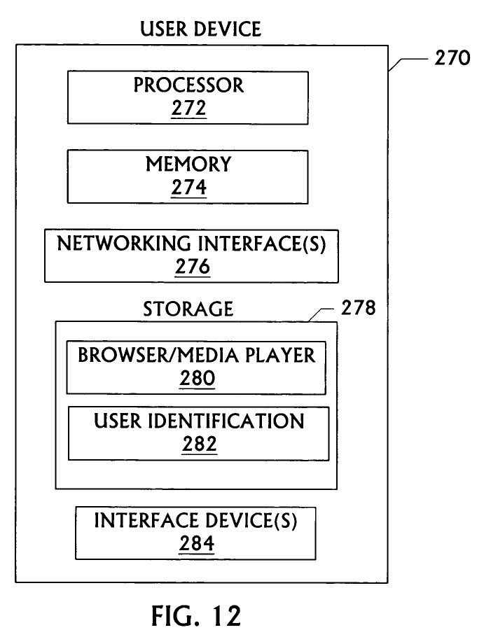

FIG. 12 depicts a user device 270. The user device 270 may include a processor 272, memory 274, networking interfaces 276, storage 278, browser media player 280, user identification 282, and interface devices 284. However, these elements may or may not be included together, separately, or in various combinations, among others.

The processor 272 and memory 274 may function together to provide the various functionalities described above and below.

The processor 272 may take various forms including a variety of computational circuitries useful in interpreting instructions and performing tasks associated with the requesting and displaying of streaming media. The memory 274 may take various forms including RAM, ROM, flash memory, floppy disks, hard disks, CDs, DVDs, removable drives, and network storage drives, among others. The storage 278 and the memory 274 may or may not be combined.

The network interfaces 276 may function to communicate with the streaming media edge servers, and management servers, among others. The network interfaces 276 may communicate through various hardwire and wired networks and may communicate with various protocols including TCP/IP, UDP, and Ethernet, among others. Further, the network interface 276 may permit the viewer to communicate using protocols such as HTTP, MMSP, RTSP, SMTP, and FTP, among others.

The storage medium 278 may take various forms including those described in relation to the memory 274. Within the storage medium 278 may be a browser/media player 280 and user identification 282, among others.

The user device 270 may include a browser and/or media player 280. This browser and/or media player 280 may permit access to a management server and an edge server for accessing streaming media files. For example, using a user identification 282, the browser and/or media player may request a broadcast from a management server. The management server may direct the browser and/or media player 280 to an edge server. The edge server may then stream the media file to the browser or media player 280 for display and interaction with the viewer.

The user identification 282 may be transferred to a management or edge server and used to track viewers, activity, and log sessions. The user identification 282 may also be used to restrict or permit access to broadcasts and channels. Further, the user identification 282 and/or network location may be used to determine quality and bit rate limits associated with the viewing device 270.

The interface devices 284 may take various forms including cameras, microphones, mice, keyboards, touch screens, and monitors, among others.

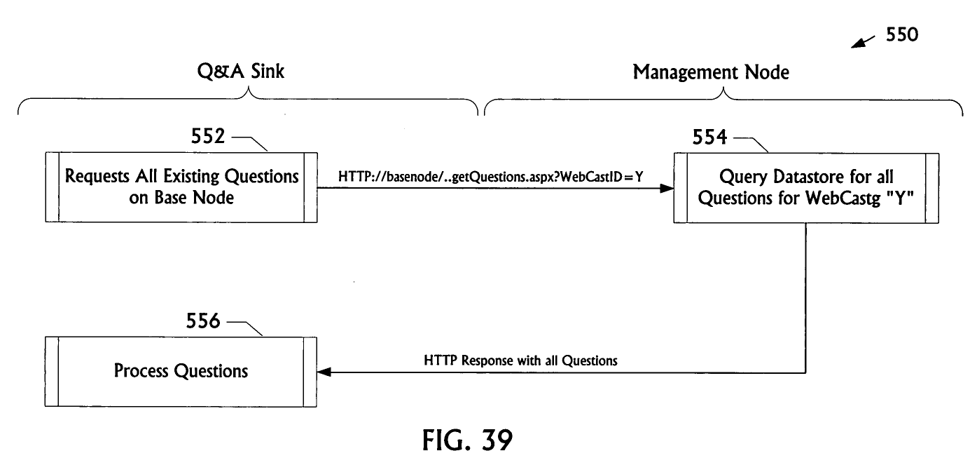

The creation device, management server, edge server, and viewer function together to provide an efficient intranet for delivering streaming media presentations. The creation device may be used to create a presentation that conforms to network limitations and various security measures. The management server may act to store archived content, deliver content to edge servers or publishing points, manage broadcasts and edge servers, respond to requests, and log activity, among others. The edge servers may store content in proximity to viewers and deliver that content as requested. The viewers may request content in accordance with their network location and associated permissions. FIGS. 13-42 describe exemplary embodiments of the system and exemplary method for use by the system.

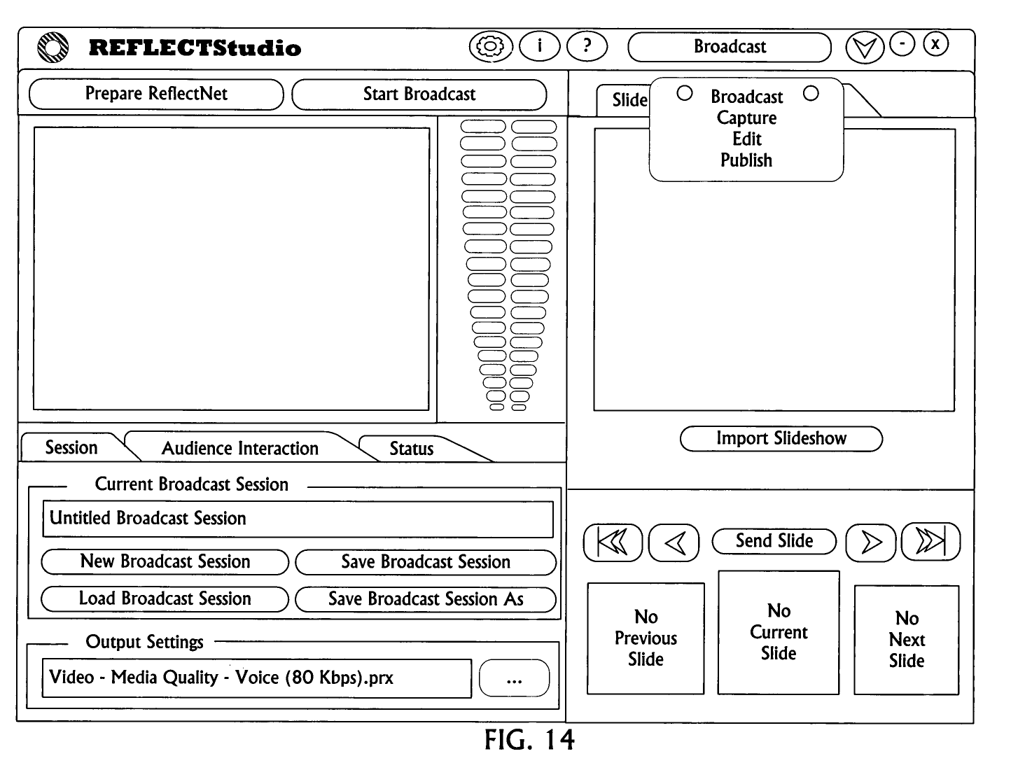

FIGS. 13-26 are pictorials depicting exemplary interfaces of a creation tool. FIG. 13 depicts the exemplary interface in a broadcast mode, as indicated by the word “broadcast” in the upper right hand corner. The interface may have a variety of properties, information, and help buttons across the top. Alternately, the interface may have a variety of pull down menus, buttons and checkboxes providing various functionalities. For example, the mode of the interface may be changed through a pull down menu as seen in FIG. 14. This exemplary interface has several modes which act to create, edit, and publish.

In the broadcast mode as seen in FIG. 13, the exemplary interface has a variety of features. In the upper left corner is a logo, herein “Reflects Studio”. Below the logo are two buttons: “Prepare Reflectnet” and “Start Broadcast.” The “Prepare Reflectnet” button may for example prompt the user for input and establish communication with a network server, management server, edge server, or publishing point. The “Start Broadcast” button may also prompt the user for information and/or facilitate the transfer of broadcast data to the publishing point or server. For example, these buttons may be used to establish communication with a server, upload slide image files, and begin the capture and transfer of audio/video media.

Below the buttons is a display area, which may be used to display the streaming media data as it is sent or, depending upon the mode, media data which may be included in the presentation.

Below this display area is a set of tabs. In this case, the tabs have the titles “Session”, “Audience Interaction”, and “Status”. The “Session” tab provides a variety of buttons and access to menus for establishing a broadcast session and saving that broadcast session locally. The “Audience Interaction” tab permits interaction with audience questions. The “Status” tab depicts a variety of buttons, icons and charts or graphics showing the status of various aspects of the system. Each of these tabs are explained in more detail in later figures.

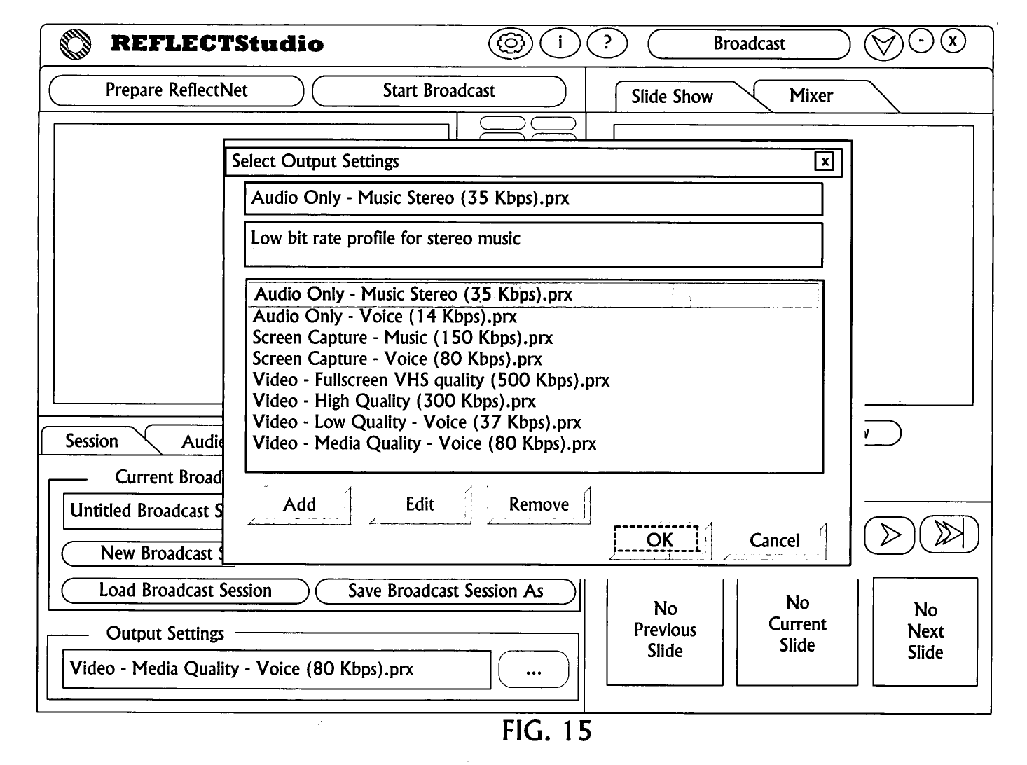

In the “Session” tab of this example, buttons are shown that permit the establishment of a “new broadcast session”, “loading a broadcast session”, “saving a broadcast session”, and “saving a broadcast session as”. These buttons establish broadcast settings and parameters and function to permit storage of these session data files on the creation device. One exemplary setting may be the output setting. FIG. 15 depicts the selection menu for the output setting. For example, a given broadcast may be communicated with the server in a variety of formats, audio only, screen capture, and video, with a variety of associated bit rates and quality. Selection of the format and quality may be limited by permissions associated with a user identification or network location. For example, 500 Kbps video may tax a connection between a remote office and a management server. As such, users at the remote office may be provided a subset of bit rates and media quality that conform to the network capacity.

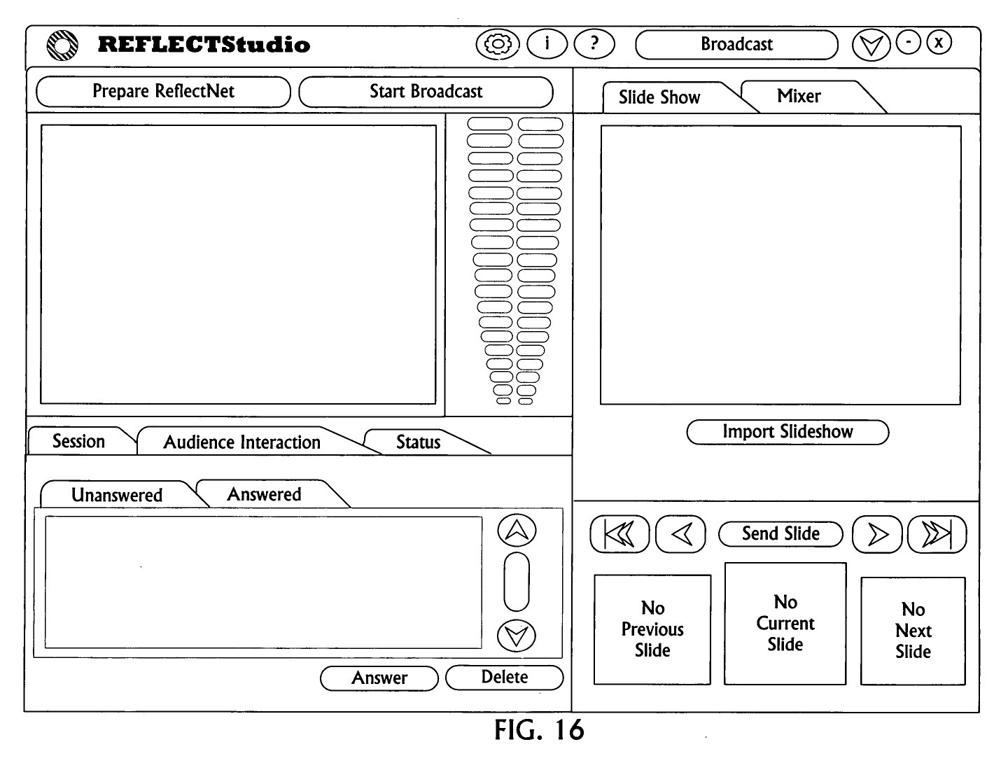

As is seen in FIG. 16, the “Audience Interaction” tab depicts another set of tabs, unanswered and answered, along with buttons for answering, deleting and scrolling through the listed questions. This tab permits the broadcaster to respond to questions typed by members of the audience. The questions typed by those members appear in the unanswered tab. As questions are answered, the presenter may select the answered button, moving those questions into the answered tab. Alternately, the user may delete the questions or scroll through the questions as needed.

In an alternate embodiment, the audience tab may be replaced with a viewer. The viewer may download data from the management server or publishing point. For example, the viewer may download an HTML document. The data may be questions from viewers, prompts, speech notes, and teleprompter comments, among others.

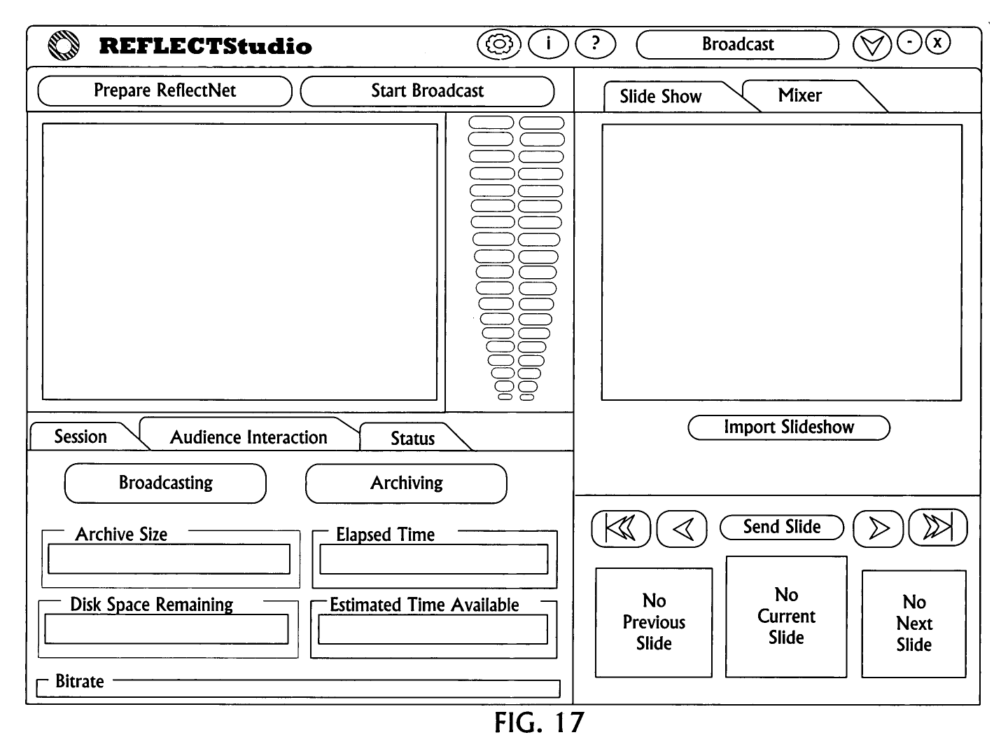

The “Status” tab may be seen in FIG. 17. In this exemplary embodiment, the “Status” tab depicts a broadcasting icon and archiving icon, which may be illuminated depending upon whether the presentation is broadcast or is being archived on a remote server or the local system. In addition, text boxes or graphical bars may be used to depict the archive size, elapsed time, disc space remaining and estimated time available, and the rate of transfer, among others. However, various graphical features and elements may be used to display data associated with the status of a broadcast.

To the right side of the interface are two tabs indicating “Slide Show” and “Mixer.” The “Slide Show” tab permits one to import a slide show such as a PowerPoint file, image set, or other slide set. Selection of the import slide show button pops up the import slide show window as seen in FIG. 18. This window allows the selection of a file containing the slide show. Once the slide show is selected, the slides may appear in the window above the import slide show button and/or below the import slide show button. For example the window above may depict a current slide and the display below may depict a set of slides: the previous slide, current slide and next slide, along with controls for manipulating which slide is selected.

If the mixer tab is selected as seen in FIG. 19, a set of buttons and a menu is provided that permits the selection, loading, and editing of input from a variety of multimedia input devices, and media files, among others. For example, an item such as a default video or audio device may be placed in the menu. If selected, details about that item may be displayed above the buttons and below the mixer tab to show the current selected device.

If a set of devices are commonly used, the mixer set may be saved and then loaded as needed. Further, other devices may be added, edited, and removed as required. For example, in any given presentation, the user may have one or more cameras, one or more microphones, and one or more image, video, or audio files, which may be mixed with slides in order to create a multimedia presentation. However, one or more of these media may or may not be used. For example, a set of video files may be combined to make a broadcast. Alternately, a camera input and set of slides may be used to create a presentation. In another example, an audio stream and screen capture may be used to create a broadcast.

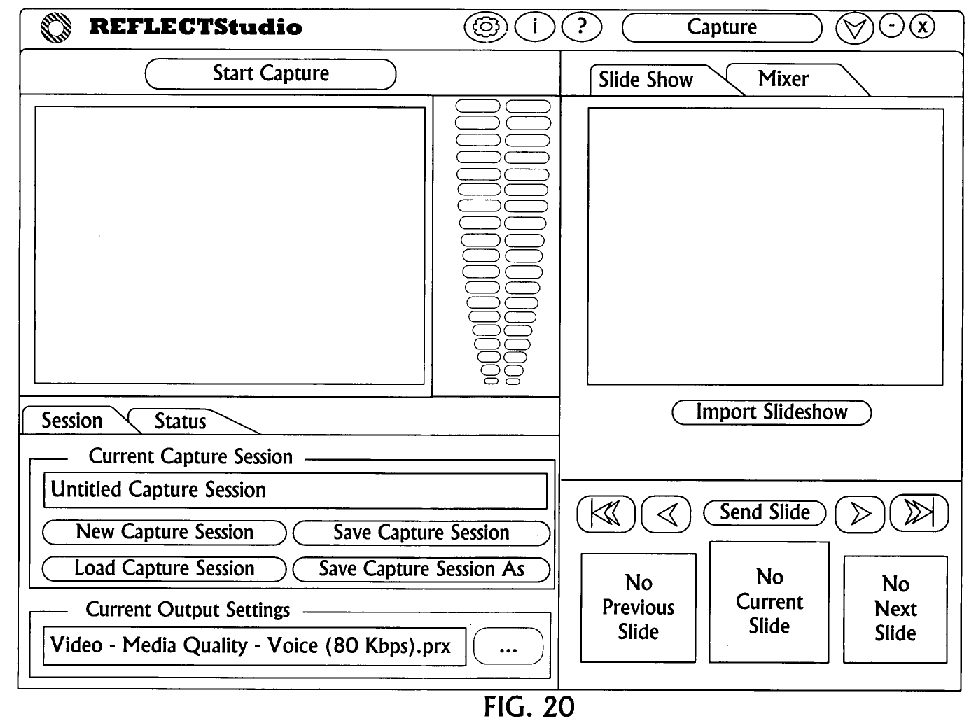

FIG. 20 depicts an alternate mode of the interface in which a presentation is captured and archived for future use. The capturing may store the presentation on a local device. Alternately, the capture may store the presentation on an archiving server. The capture mode has a similar interface in which the start capture button begins the capture of a video stream seen in the window below the start capture button. The session and status tabs below the streaming media window permit the establishment of settings and display the status of the presentation. To the right, the slide show tab and mixer tab are used to import the slide show and intermix various streaming media into the captured presentation. The display to the bottom right side of the screen depicts the current slide, the previous slide and the next slide, along with buttons for manipulating which slide is currently selected. Together or in various combinations, these slides and media captured through the mixer may be combined to provide a presentation. The capture mode and broadcast mode may be combined into a create mode with similar features to the broadcast mode.

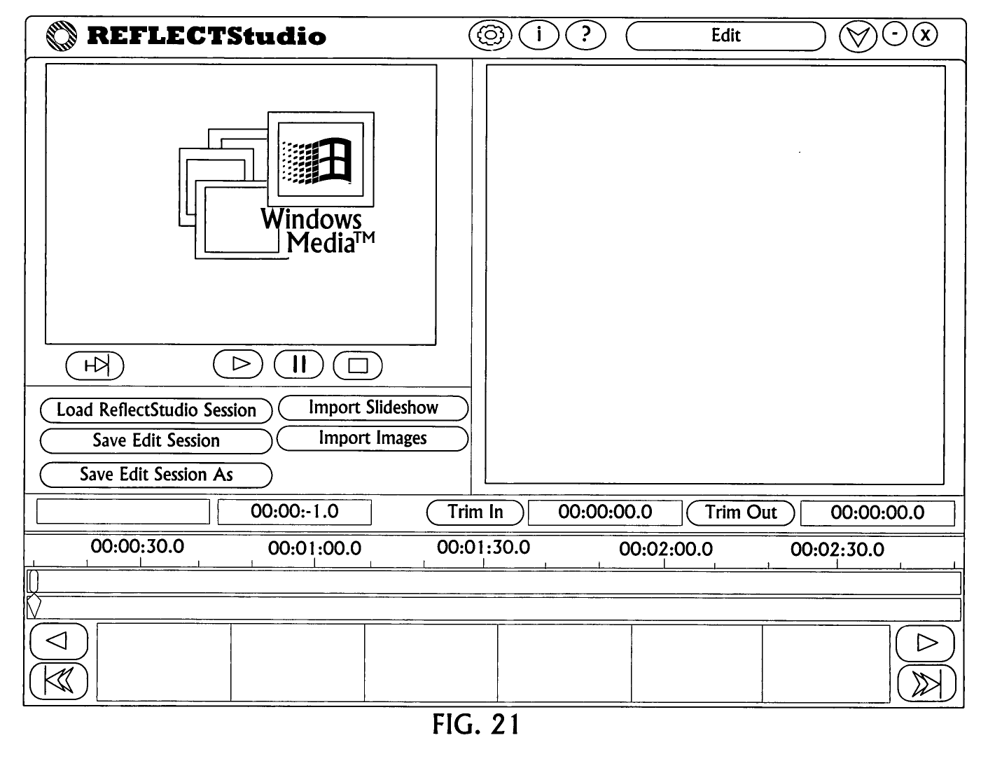

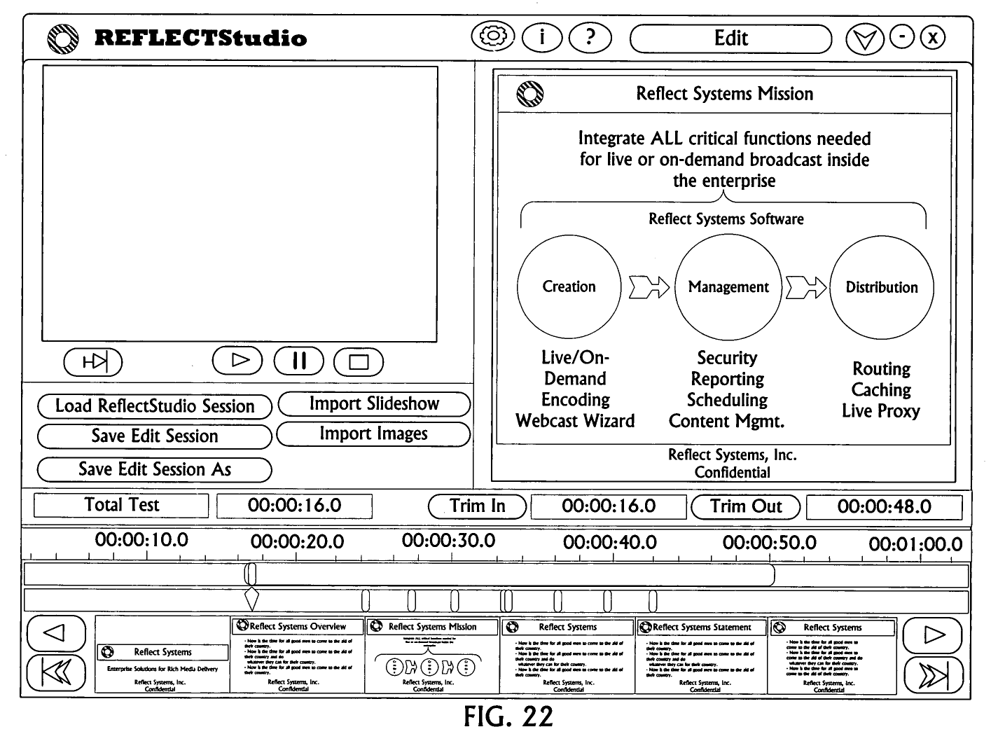

FIG. 21 depicts a further mode, the edit mode. The edit mode permits the editing of captured or archived presentations. The edit mode has a media window, in this case indicated as the Windows Media™ window. Below the media window is a set of controls for controlling the media flow. Below these controls are buttons permitting the loading of various sessions, importing of slide shows and images, and saving of edit sessions. To the right of the streaming media window is a large window, which may be used for displaying a current slide. Below these is a timeline with an icon depicting the location within the captured presentation represented in the media window. Below the timeline is a region for depicting slides that are available to the presentation.

FIG. 22 depicts an exemplary presentation once loaded into the edit session. In this exemplary embodiment, the media is depicted as the darkened space along the timeline bracketed by two icons. Below the first icon to the left is an indicator of location within the presentation.

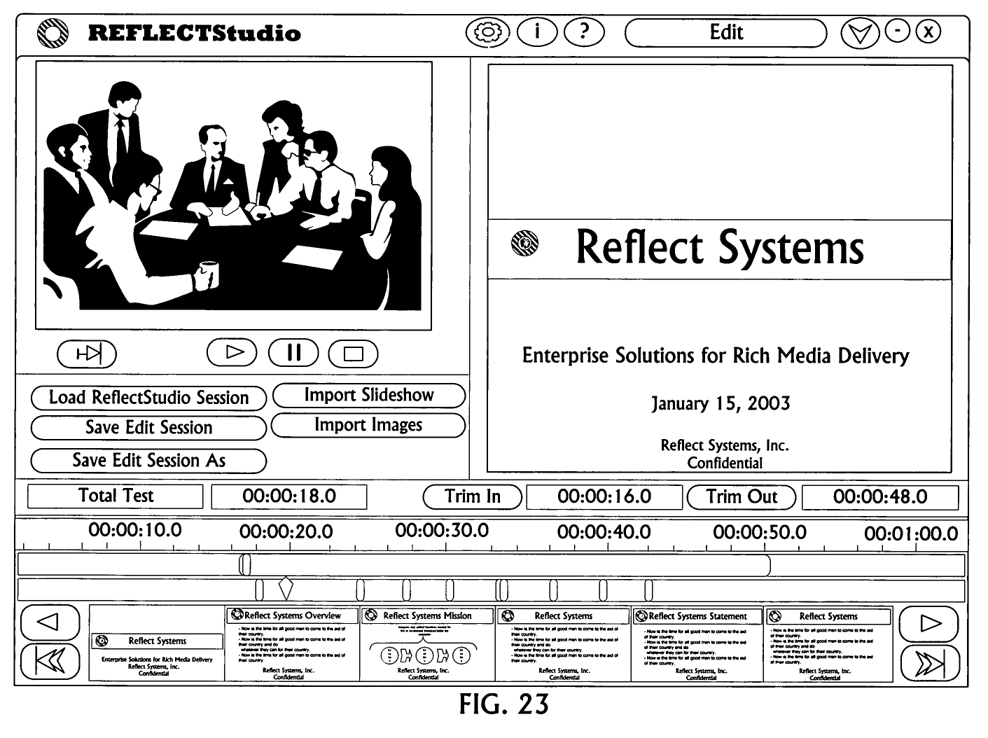

In a row below the timeline are icons depicting the location of slide transitions. One of these transitions is highlighted resulting in the display of the slide associated with that transition in the upper right hand window. Various media formats permit the encoding of image or slide transfers within their streaming media. Once loaded, a session or media file is decoded to permit the interpretation and display of these transitions along a timeline as indicated below. This edit tool permits the manipulation of these transitions using an easy drag and drop interface. As is seen in FIG. 23, the transition markers may be rearranged from those seen in FIG. 22 to provide for an improved presentation.

Another feature of the system is the trim in and trim out buttons. These buttons may be used to trim unwanted streaming media from the presentation. Along the timeline, the end icons may be moved and video trimmed from the end based on the position of the icons. However, various instances or mechanisms may be envisaged in which streaming media may be edited from the middle.

In addition, mixer markers may be used to indicate transitions in mixed media. Examples of these markers may be seen in the time line. In this example, only one media stream was used. The mixer markers therefore mark the beginning and end of the presentation in the timeline. However, if other media files were intermixed into the presentation, these markers may be used to indicate the locations of the transitions. For example, a streaming presentation from a camera may be intermixed with a prerecorded video file. The markers would mark the boundaries between the camera output and the mixing of the video file. In another example, multiple cameras may be intermixed to provide for differing angles of view. The markers may mark the transitions between camera inputs.

Once edited, the session may be saved, archived or stored for use in an on-demand archive or for mixing in other presentations.

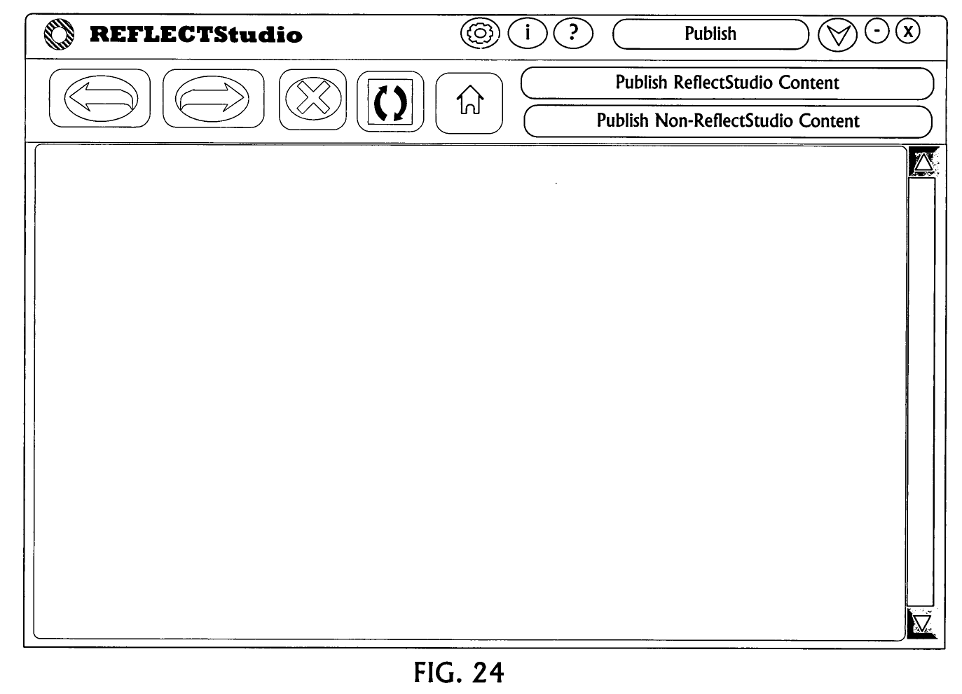

FIG. 24 depicts another mode, the publish mode. The publishing window depicts a window that may access the publishing server or management server. In this example, the publishing window acts much like a browser, communicating with the central server in an HTML format.

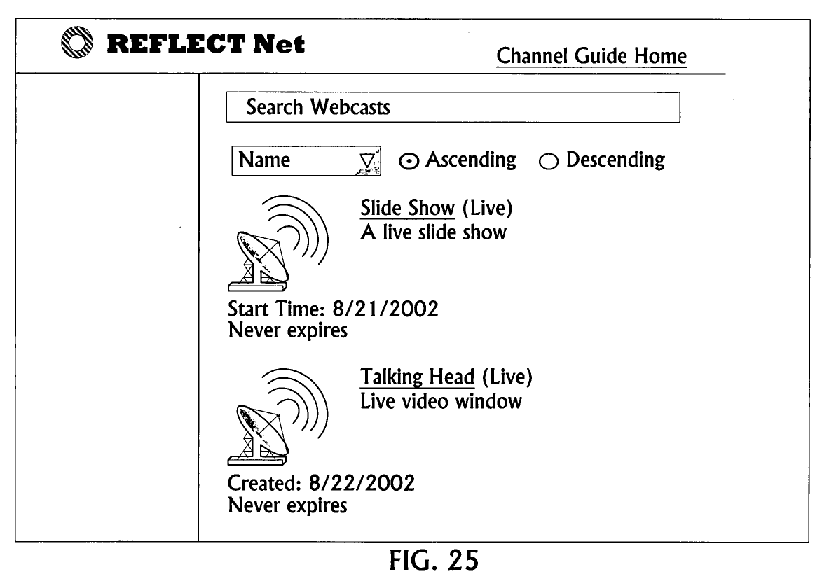

FIG. 25 is a pictorial of an exemplary page listing available broadcasts, herein termed webcasts. The webcasts may take various forms including live shows, archived shows and presentations, and on-demand presentations, among others. The listing may be sorted in various manners and may include various data associated with the presentation, including start time, expiration time, size, running length, and author information, among others. A content creator may, for example, access archived slideshows through a similar window. In another exemplary embodiment, a viewer may select a presentation for viewing.

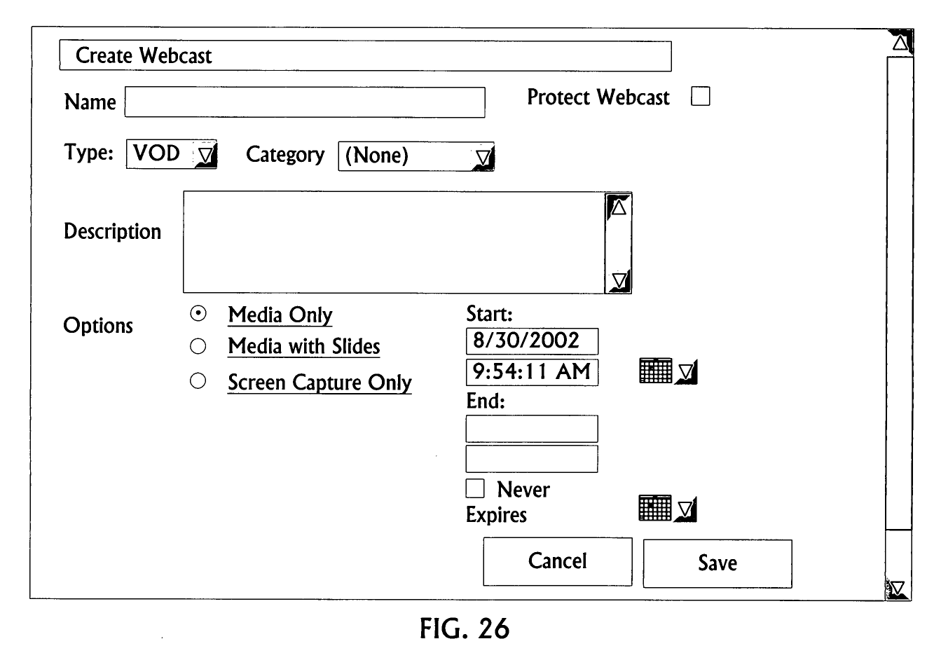

FIG. 26 is a pictorial representing an exemplary page for creating a webcast. This page may, for example, be an HTML page accessible through the published node on the creation tool. Data collected in the page may be uploaded to a management server or publishing point. The page may include controls for entering a name for protecting the webcast, for selecting a type and category, providing descriptions, and providing media options and time indicators. The type may take various forms such as a live broadcast, a video on demand broadcast, or archiving broadcast, among others. The categories may take various forms including entertainment and technical, among others. A content creator may also provide a description of the webcast, an indication of what media is to be used, and a start time. In addition, the creator may provide an end time or an expiration date for the presentation.

Upon saving, the data may be uploaded to a management node or publishing point where a channel or webcast is established. The creator may then broadcast into this channel or webcast and have that channel or webcast accessed by various viewers associated with the network.

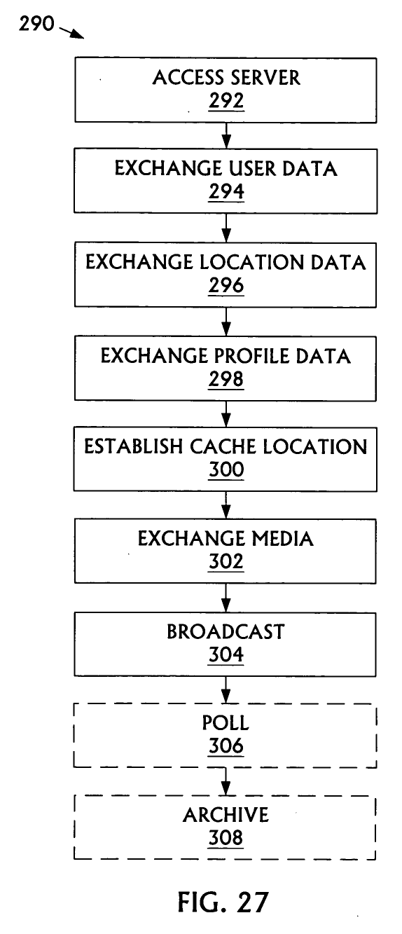

FIG. 27 is a block flow diagram depicting an exemplary method for creating a broadcast. The method 290 begins with accessing the server as seen in block 292. For example, the creation tool may poll a server using various network messages or HTTP packets to determine the availability and location of the server. The server and creation tool may then exchange user data as seen in block 94 and location data as seen in block 296. Steps 292, 294 and 296 may all be accomplished in a single packet or in various combinations of packets, among others. The user data and location data may be used by the server to determine what level of access is to be provided to a user and what limitations to place on the user as a result of network location. For example, the user at a branch office with a high capacity connection may be provided with all options for data transfer or streaming media quality. However, the user at a branch location with a low capacity connection to the intranet may be provided with a limited set of data rate and streaming media quality options. As a result, the server and creation tool exchange profile data as seen in block 298. The profile data may include limitations on transfer rates and a subset of streaming media quality options. In addition, the profile data may include channel name, broadcast type, category, description, start and end times, and media options, among others.

The creation tool may also attempt to establish an archive location as seen in block 300. The archive location may be the management server. However, in cases where users are to access the presentation through a common edge server, the edge server may serve as an archive location. In an alternate embodiment, the exchange of profile data and the establishment of an archive location may be replaced by the selection of a preset webcast channel.

The archive location and creation tool then exchange media as seen in block 302. This media may include slides, images, audio files, video files, and streaming media files, among others. The content creator may then broadcast the presentation. This may involve creating a streaming media file from an input device such as a microphone or a camera. The broadcast may also take the form of screen captures and other input.

During the broadcast, the creation tool may also periodically poll the server or archive location for feedback, input or questions from viewers as seen in a block 306. For example, the viewers may be provided with a means of typing questions that are then transferred to the server and subsequently transferred to the creation tool. In addition, the creation tool may instigate an archiving of the broadcast as seen in block 308. The archiving may take place on a local drive associated with the creation tool or at the archive location or management server.

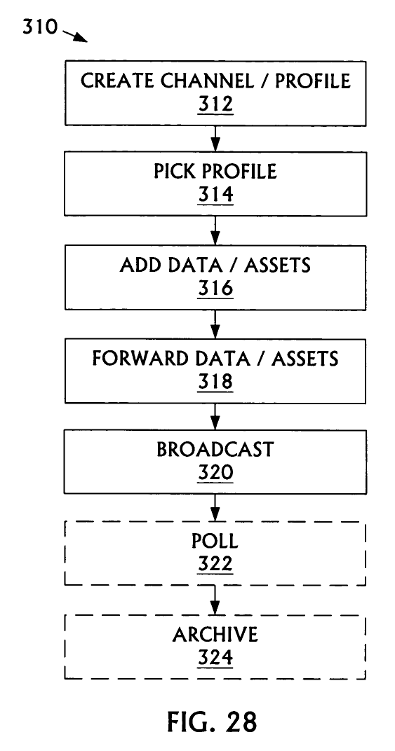

FIG. 28 depicts another exemplary embodiment of the method for creating a streaming media presentation. The method 310 begins with the creation of a channel or profile as seen in block 312. The creation of the channel or profile involves the communication and establishment of data associated with a broadcast channel such as name, description, type, category, media type, transfer rates, start time, end time, expiration dates, and other options. The channel or profile may then be presented to the user in a list of available channels or profiles. The user may pick the channel or profile as seen in block 314 and establish parameters for broadcasting a streaming media presentation.

As seen in block 316, the user may add data or media assets for use in the presentation. This for example may be seen in the mixer tab of FIG. 19. The data or assets may take the form of images, slides, data files, audio files, video files, streaming media files, and various inputs, among others. These data and assets may then be forwarded to the archive location as seen in block 318. The archive location may be management server or an edge server, among others.

The content creator may then broadcast the presentation as seen in block 320. This broadcast may include a gathering of streaming media data from input devices such as mice, cameras, microphones, screen captures, and touch screen displays, among others. The broadcast may further include timing signals, slide or image transitions, and/or the splicing of other streaming media data. During the broadcast, the creation tool may periodically poll the server for questions as seen in block 322. Further, the creation tool may instigate the archiving of the broadcast as seen in block 324. The archive may occur on a local device or on the archive location server, among others.

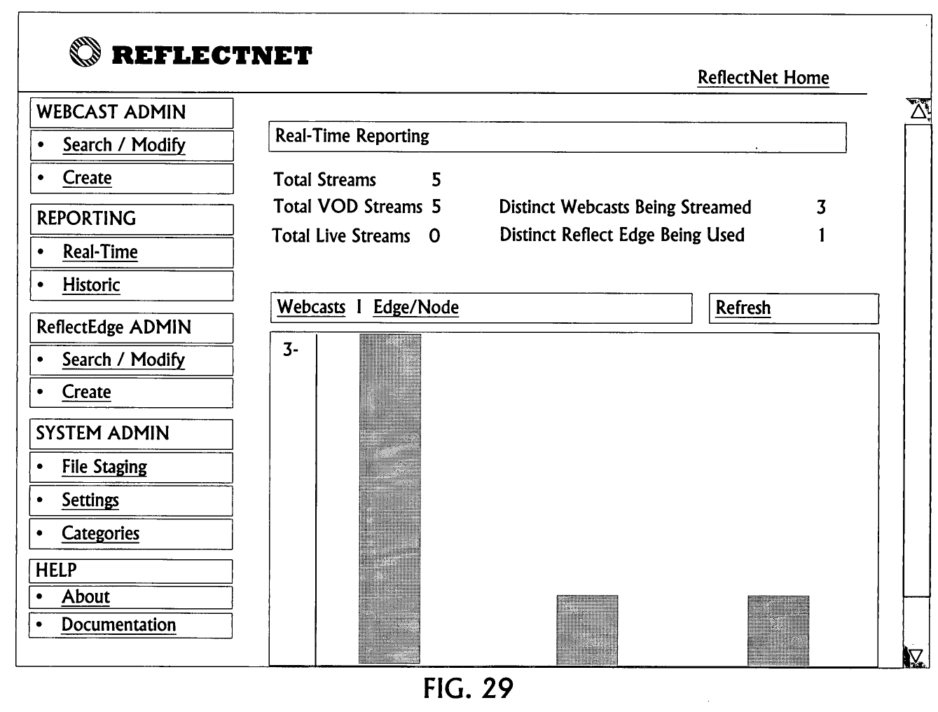

The management server may also have various interfaces. These interfaces permit management of the network and broadcast, among others. FIG. 29 depicts one exemplary embodiment of an interface for a management server. This exemplary interface is an HTML-based interface. Through this interface, a user may search and create webcasts, study usage statistics, manage edge servers and perform other system administration functions. Access to these functionalities may be limited by user identification.

In this exemplary page, a menu is provided on the left side. On the right side is a display of data associated with the webcasting. This reporting may include data such as the number of streams, the number of streams subdivided by type and the number of distinct webcasts being used. Other options and charts may be provided as well.

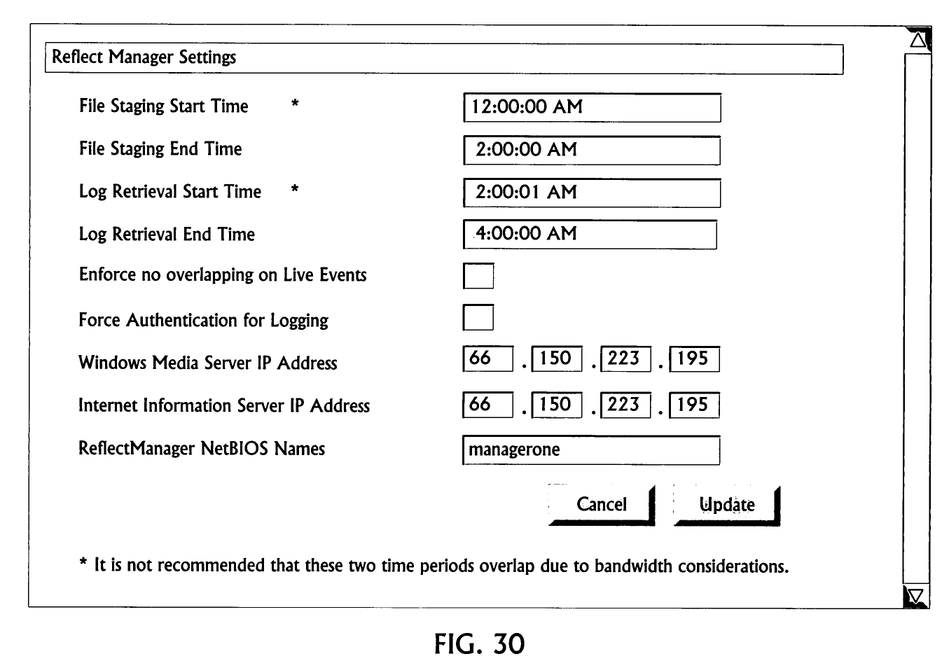

FIG. 30 depicts an exemplary interface for managing the management node. Data such as start and end times for file staging, starting and end times for log retrieval, options for overlapping with live events, authentication options, IP addresses, and network names may be managed from various screens and interfaces.

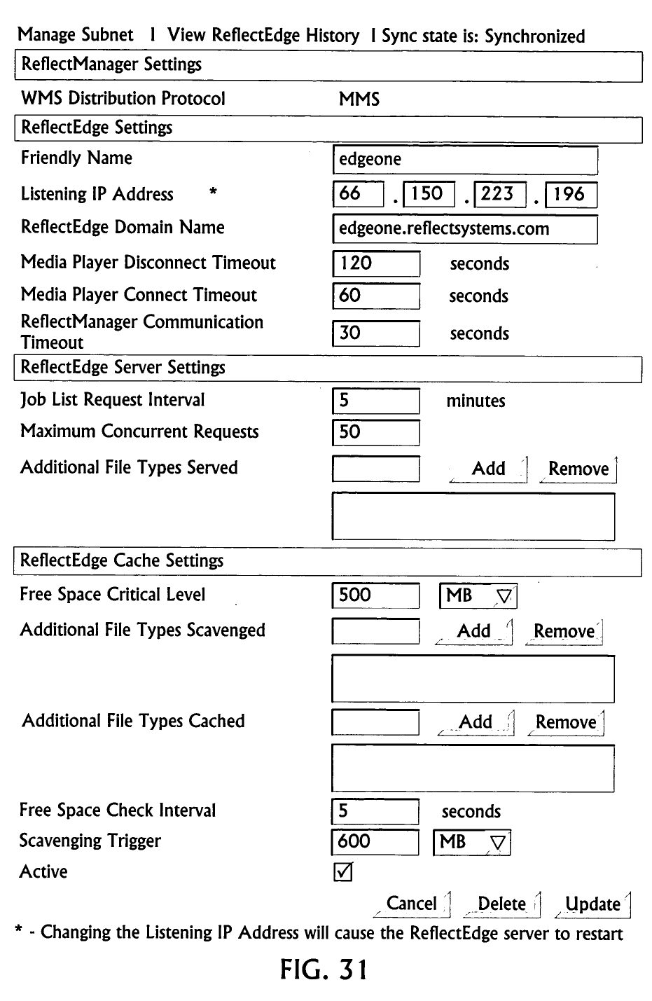

FIGS. 31A and 31B depict an exemplary management screen for edge servers. These screens may include identifying names, IP addresses, and domain names. In addition, the data may include time out options, task or job list request intervals, file management and caching settings, among others. This interface may also be presented as an HTML document.

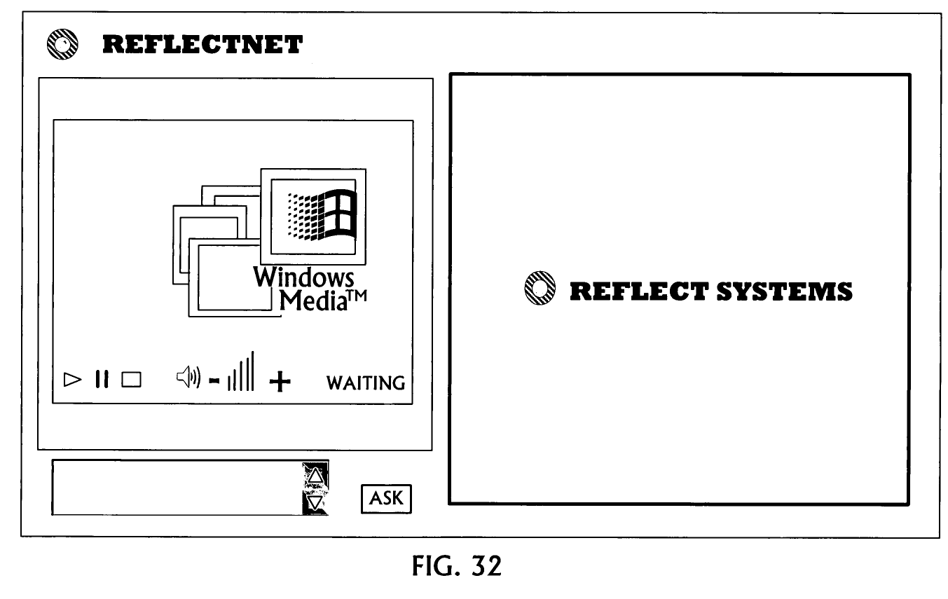

FIG. 32 depicts and exemplary browser and media player interface for use by a viewer. In this exemplary embodiment, the media player may be launched from a Web browser such as Internet Explorer™ or Netscape™, among others. A screen is presented for the Windows Media™ streaming media. In addition, to the right is an area for presenting a slide or image. Further, the bottom left hand corner includes a location or textbox for entering questions and a button to facilitate the transfer of that question. In another webpage, a user may select a broadcast. Then, the viewer window of FIG. 32 may be launched and the streaming media requested from an edge server.

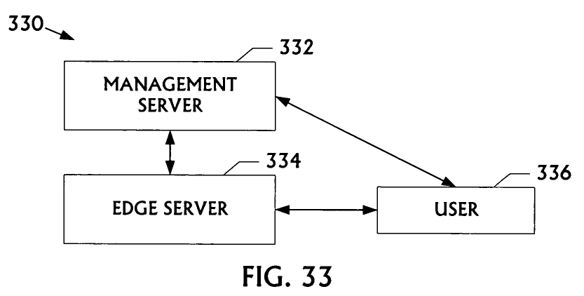

FIG. 33 is a schematic block diagram depicting the communication between the viewer 336, the management server 332 and edge server 334. The viewer 336 may request a list of available broadcasts from the management server 332. This request may include the user identification and network location of the user 336. The management server 332 may respond to the user 336 with a listing of available broadcasts or on-demand presentations. The user 336 may then select one of these broadcasts from the management server 332. This information transfer may take various forms including HTTP communication and HTML or XML Web pages, among others.

Once a broadcast is selected by the user 336, the management server 332 will send to the user 336 a location and version of the desired streaming media. The location is typically the edge server 334. The user 336 then requests the streaming media from the edge server 334, including in the request the version of the streaming media. The edge server may test to determine whether it has the appropriate version of the file. If it does not, the edge server may retrieve the file from the management server 332. The edge server 334 may simultaneously cache the file it is retrieving from the management server 332 and distribute the media.

For on-demand presentations, the management server 332 may, through the job list, direct the edge server 334 to download frequently used files during off-peak times or at set times. If multiple users are accessing the edge server 334, this limits the amount of network traffic occurring across the network between the management server 332 and the edge server 334.

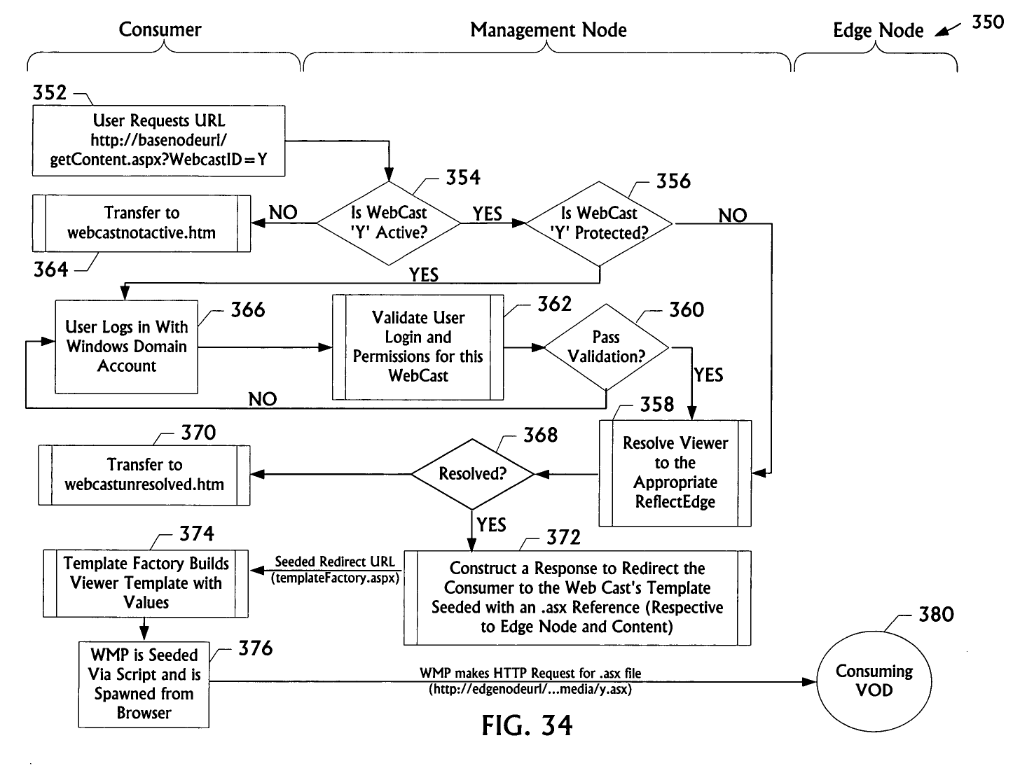

FIG. 34 depicts a method 350 for requesting media. A user requests the media as seen in block 352 from a management node. The management node determines whether the webcast is active, as seen in a block 354. If the webcast is not active, the management node transmits back to the consumer a webcast not active page as seen in block 364. However, if the webcast is active, the management node determines whether the webcast is protected as seen in block 356. If the webcast is protected, the management node requires a user login as seen in block 366.

As seen in blocks 362 and 360, the management node determines whether the user has permission to view the webcast. If not, the user may be prompted to reenter login information as seen in block 366. However, if the user does pass validation, or the webcast is not protected, the management node determines which edge node is to be responsible for the broadcast as seen in block 358. If the management node is not able to determine an edge node as seen in block 368, a webcast unresolved page is sent to the consumer as seen in block 370. However, if the edge server is resolved, the management node constructs a response to redirect the consumer to content on the edge node as seen in block 372. The consumer then builds a template as seen in block 374 and spawns a window as seen in block 376. The window then requests the webcast from the edge node as seen in block 380.

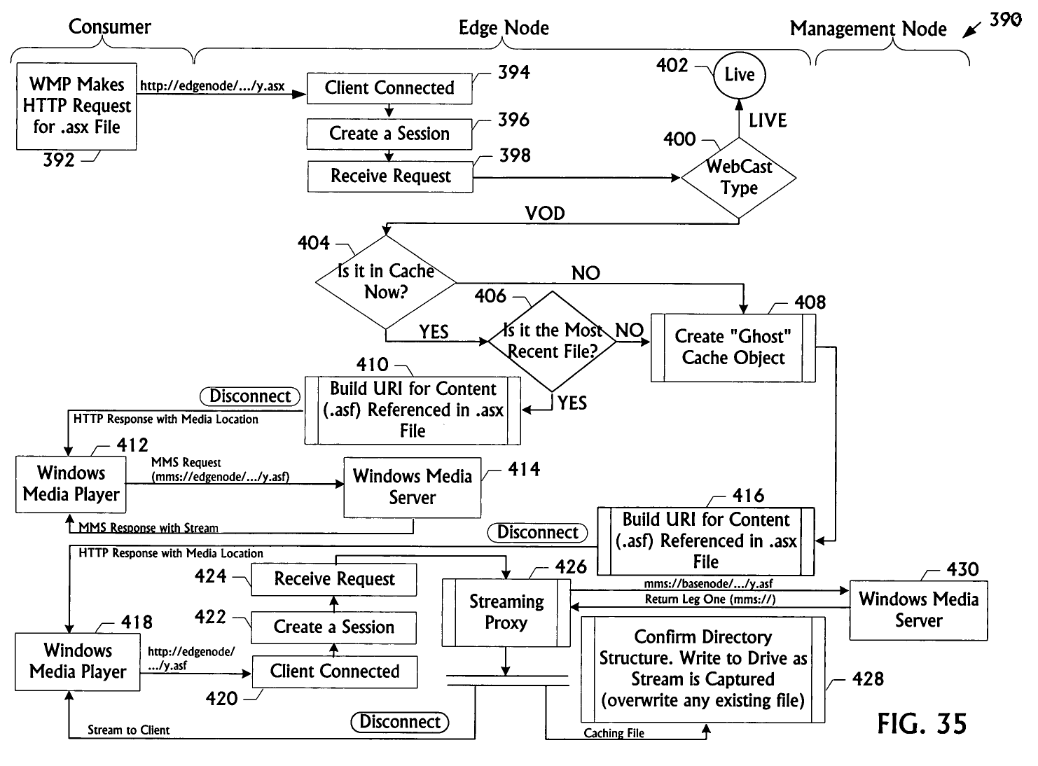

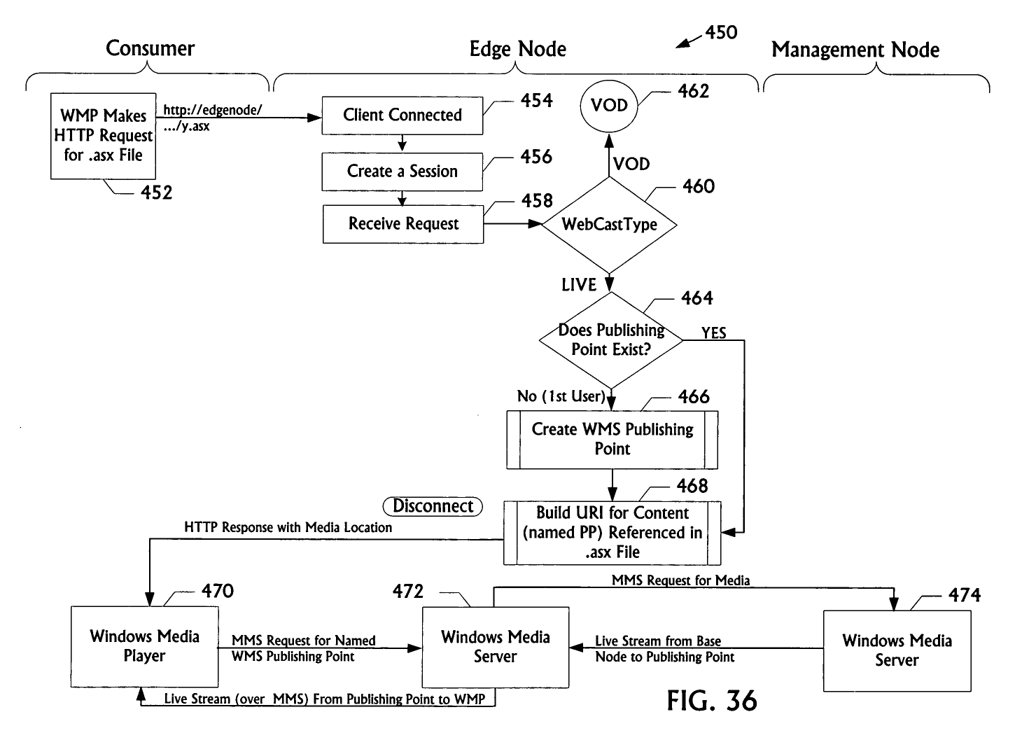

FIG. 35 depicts an exemplary method 390 for consuming on-demand streaming media presentations from an edge node. A spawned window requests a file from an edge node as seen in block 392. The edge node determines whether the client is connected, creates a session and receives the request as seen in block 394, 396 and 398. The edge node then determines what type of webcast has been requested as seen in block 400. If the request is for a live webcast, the client is directed to the method as seen in FIG. 36. However, if the webcast type is for a video-on-demand or on-demand presentation, the edge node determines whether the presentation or media are in cache as seen in block 404. If the media is in cache, the edge node may determine whether this is the most recent file as seen in a block 406. This may be performed by checking version numbers included with the request from the consumer. If the most recent request is available and in cache, the edge node may build a file as seen in block 410. The media player may be launched on the consumer as seen in block 412 and request the media from the edge node as seen in block 414. For example, the player may be launched as part of a template page provided by the edge server. The edge node then serves the media back to the windows player 412.

If the media is not in cache, the edge node may create a ghost cache object as seen in a block 408. The system may then build a file as seen in block 416 that results in the launching of the Windows™ Media™ player on the consumer device as seen in block 418. In this case, the Windows Media™ player responds back to the edge node. The edge node connects the client, creates a session and receives a request as seen in blocks 420, 422 and 424, respectively. Then, the edge node creates a streaming proxy 426. This streaming proxy requests the streaming media from the management node media server 430. The media is returned to the streaming proxy which writes the file to cache while simultaneously streaming the file to the Windows Media™ player 418.

FIG. 36 depicts a consumer requesting a live event. If the media to be consumed is associated with a live event, the consumer may again request the media as seen in a block 452. Here too, the edge node connects the client, creates a session and receives the request as seen in blocks 454, 456 and 458, respectively. The webcast type is tested as seen in block 460. If the webcast type is a video-on-demand or on-demand media, the method of FIG. 35 is used as seen in block 462.

However, if the webcast type is live, the edge node determines if a publishing point exists. If a publishing point does not exist, the edge node may create a Windows Media™ server publishing point as seen in block 466. This may be the case if this is the first user requesting the live file. If the publishing point exists or one is created, a file is built as seen in block 468, resulting in the launching of the Windows Media™ player as seen in block 470. The Windows Media™ player requests the media from the Windows Media™ server 472, which in turn requests the media from the Windows Media server 474 located at the management node. Subsequently, the media is transferred from the Windows Media™ server 474 to the Windows Media server 472 and out to the Windows Media™ player 470. Streaming media may contain references to slides and images.

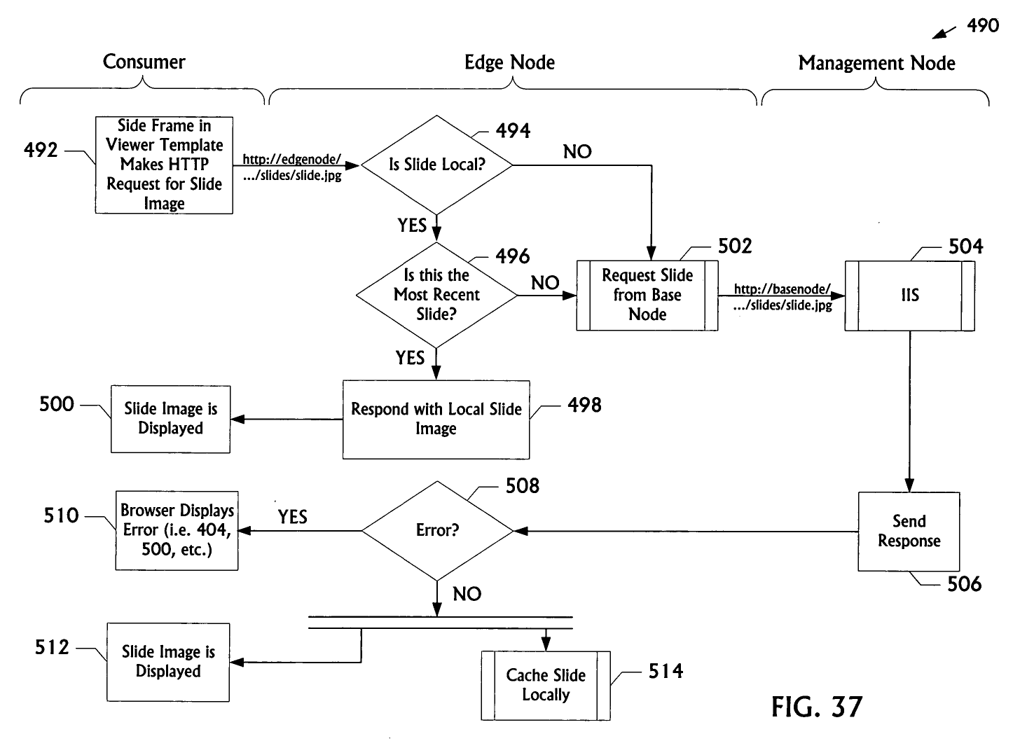

The method 490 of FIG. 37 depicts the consumption of slides. A consumer template makes a request for a slide as seen in a block 492. The edge node determines if the slide available locally, as seen in a block 494. If the slide is available locally, the system determines whether this is the most recent slide as seen in a block 496. This may be performed by using version numbers requested through the consumer. If the slide is the most recent one, the server may respond with the local slide image as seen in a block 498 and the slide may be displayed by the consumer as seen in a block 500.

If the slide is not the most recent slide or the slide is not available locally, a request for the slide may be made from the management node. The Internet information server 504 on the management node may send a response as seen in a block 506 to the edge node. The edge node may then determine whether an error has been made as seen in a block 508. If an error is detected, a browser error message may be displayed on the consumer device as seen in 510. However, if an error is not detected, the slide may be simultaneously cached locally as seen in a block 514 and displayed by the consumer as seen in a block 512.

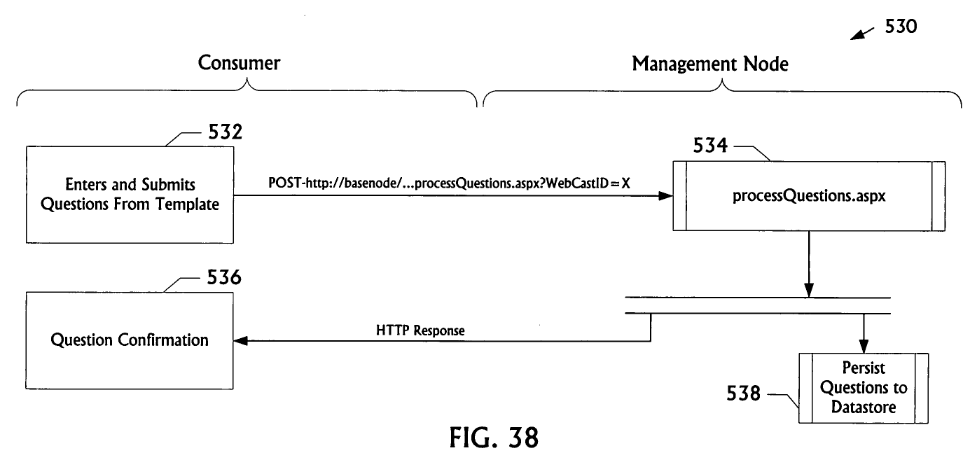

FIG. 38 depicts a method for publishing questions. Oftentimes, during a presentation a template may be provided that permits the submission of questions by a viewer. The method 530 begins with a consumer entering a question through a template. The question may then be posted to the management node as seen in a block 534. The questions are then persisted to a data store as seen in a block 538 and the consumer is sent a confirmation that the question was received as seen in a block 536.

The presenter may then retrieve the questions and answer them. The method 550 seen in FIG. 29 may start with a request as seen in block 552. The management node may then query the data store as seen in block 554 and respond with all the available questions as seen in block 556. The presenter may then respond to these questions as desired either through audio feeds or other inputs.

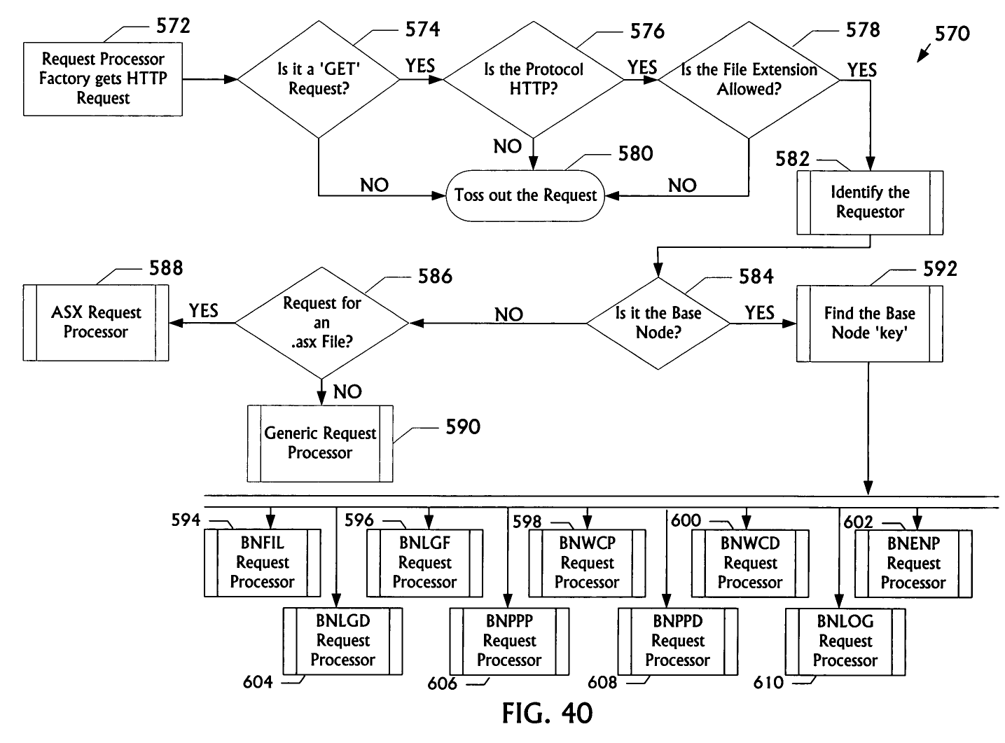

FIG. 40 depicts an exemplary method 570 for processing requests on an edge server. The method 570 begins with the receipt of a request as seen in block 572. The edge server determines whether the request is an HTTP GET request for a file with a permissible file extension as seen in blocks 574, 576, and 578. If the request is not, the request is ignored or deleted as seen in block 580.

If the request is an HTTP GET request for a file with a permissible file extension, the server may identify the requester as seen in block 582. This identification may be the recognition of a network address or testing the login of the user, among others.

The edge server then determines whether the request is from a management node. If the request is not from a management node, the server tests to determine whether the file is a .ASX file. If it is, the server uses and ASX request processor as seen in block 588. If is not a .ASX file request, the server uses a generic request processor as seen in block 590.

However, if the request is from a management node, the server seeks a management node key as seen in block 592. The key may determine which processor to use. For example, the key may indicate the use of the BNFIL request processor 594. The BNFIL request processor 594 directs the edge node or server to make it's own HTTP request to the management node for a content artifact. The BNLGF request processor 596 processes request for a specific Windows Media Server™ log located on the edge node. The BNWCP request processor 598 directs the edge node to make it's own HTTP request to the management node for an updated webcast profile. The BNWCD request processor 600 processes requests for the edge server to delete a webcast. The BNENP request processor 602 processes command for the edge node to make an HTTP request to the management node for an updated edge node profile. The BNLGD request processor 604 directs the edge node to delete its Windows Media Server™ log. The BNPPP request processor 606 directs the edge node to create a Windows Media Server™ publish point. The BNPPD request processor 608 directs the edge node to delete a Windows Media Server™ publishing point. The BNLOG request processor 610 processes request for a listing of Windows Media Server™ logs located on the edge node. Other processors may be used to direct the deleting of files and other functions. The HTTP GET method may be used in conjunction with a job or task list periodically accessed on the management server or node.

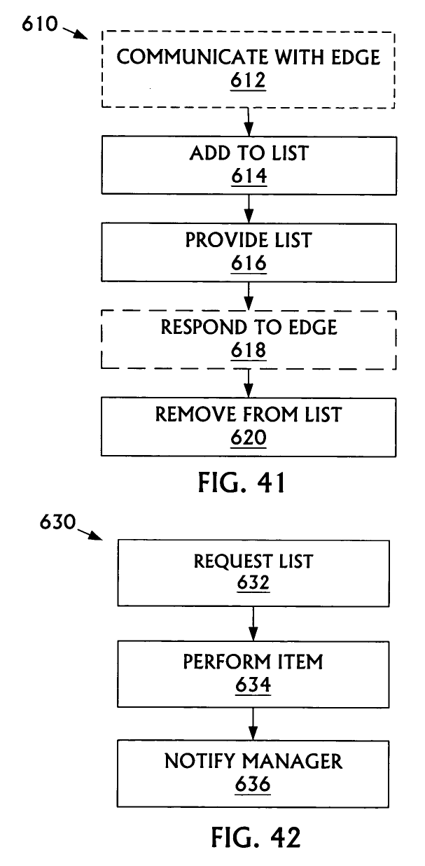

FIG. 41 is a block flow diagram depicting an exemplary method for managing edge servers. The method 610 may begin with communication from the management server to the edge server as seen in block 612. This communication may be a command, a notification that a task is to be added to a task list, or other communication. For example, a command may be issued through the method of FIG. 40. However, there may or may not be communication with the edge server directly. The task is then added to a task or job list as seen in a block 614. The task or job list may reside on the management node. The management node may then provide the list as seen in a block 616 as requested by the edge server. The task or job list may include requests for configuration changes, cache management commands, instructions for downloading streaming media files, and instructions for providing log files, among others. The job may require that the edge server retrieve the data from the management server. As such, the management server may respond to requests of the edge server as seen in a block 618 with the data requested. Once the task is completed, the edge server may notify the management server that the task is completed and removed from the task or job list as seen in a block 620.

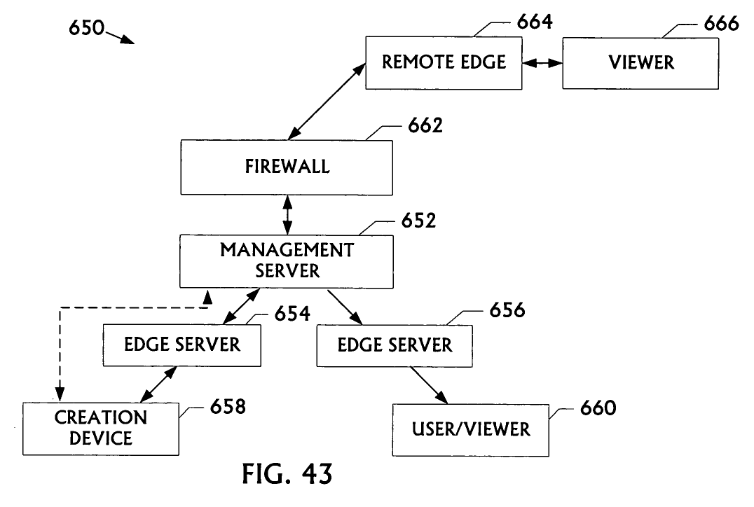

The edge server as seen in FIG. 42 may request the list or items on the list from the management server as seen in a block 632. This request may be made at established times or periodically. Once an item is retrieved, the edge server may perform that item as seen in block 634. For example, the edge server may download a new version of a video-on-demand file. Alternately, the edge server may perform a reconfiguration as directed. However, various tasks may be envisaged. Once the edge server has performed the task, the edge server may notify the management server as seen in a block 636. In this manner, the management server may acknowledge the performance of that task and remove the task from the list.

In another exemplary embodiment, network may establish a remote edge server to communicate with external viewers. FIG. 43 depicts an exemplary structure for use by the system. The management server 652 is connected to the edge servers 654 and 656, the creation device 658, and the user/viewer 660. As described above, the creation device 658 may stream a presentation to the management server 652. The presentation stream may then be distributed to the edge servers for streaming to users.

Similarly, the management server 652 may stream the media to a remote edge server 664. The remote edge server 664 may act similar to the edge servers 654 and 656 in that it provides media to multiple users while acquire that media from the management server. However, the remote edge server 664 may also act to present broadcast options and lists in a manner similar to the management server. As such, communication through the firewall 662 may be limited to requests from the remote server 664.

As such, networks, methods, and devices are described in relation to an efficient, secure, streaming media system. In view of the above detailed description of the present invention and associated drawings, other modifications and variations will now become apparent to those skilled in the art. It should also be apparent that such other modifications and variations may be effected without departing from the spirit and scope of the present invention.

What is claimed:

1. A network, comprising:
at least one management server, wherein users create content and access said at least one management server to establish broadcast channels or publishing points, and wherein said users stream a media file to said at least one management server for broadcast or storage;
a plurality of edge servers; and
viewers that request a media stream from said at least one management server, wherein said at least one management server redirects said viewer to an edge server that transmits said media stream to said viewer.

2. The network of claim 1, wherein said at least one management server comprises:
at least one network interface; and
an archive for storing media streams.

3. The network of claim 1, wherein said at least one management server comprises an edge server task list and edge configuration files, wherein said edge server task list is accessed by edge servers to periodically acquire a task.

4. The network of claim 3, wherein said task is associated with configuring said edge server using said edge server configuration file or data supplied in said task listing.

5. The network of claim 2, wherein said task list directs said edge servers to download data from an archive.

6. The network of claim 1, wherein said at least one management server comprises a permissions list, wherein said permission list is used to ascertain which functions are provided to which users.

7. The network of claim 1, wherein a user is provided with a subset of a channels or broadcast settings with which said user can create a streaming media presentation.

8. The network of claim 1, wherein said at least one management server collects subscriber data to track viewers.

9. The network of claim 1, wherein a user interface within said at least one management server permits access to and configuration of said at least one management server.

10. The network of claim 1, wherein communications within the network utilize HTTP.

11. A method for accessing media files comprising the steps of:
a viewer communicating with at least one management server to request a media file;
directing said viewer to acquire a media stream with a given version number from an edge server, said viewer then requests said media file with said version number from said edge server;
ascertaining whether said requested version of said media file is located on said edge server, wherein if said media file is not located on said edge server, said edge server acquires said media file from said at least one management server;
caching and broadcasting said media file to said viewer.

12. The method of claim 11, wherein said media file comprises a broadcast, streamed or archived file.

13. The method of claim 11, wherein said viewer periodically pings said at least one management server or edge server to inform said servers of said viewers presence or to transfer questions entered by said viewer.
